(19) United States
(12) Patent Application Publication
(10) Pub. No.: US 2013/0170598 A1
(43) Pub. Date: Jul. 4, 2013

(54) NUCLEAR REACTOR CONTAINMENT VESSEL

(71) Applicants: Mitsuo KOMURO, Kanagawa (JP); Noriyuki Katagiri, Kanagawa (JP); Masashi Tanabe, Kanagawa (JP); Toshimi Tobimatsu, Chiba (JP); Yuka Shibasaki, Kanagawa (JP)

(72) Inventors: Mitsuo KOMURO, Kanagawa (JP); Noriyuki Katagiri, Kanagawa (JP); Masashi Tanabe, Kanagawa (JP); Toshimi Tobimatsu, Chiba (JP); Yuka Shibasaki, Kanagawa (JP)

(73) Assignee: KABUSHIKI KAISHA TOSHIBA, Tokyo (JP)

(21) Appl. No.: 13/680,512

(22) Filed: Nov. 19, 2012

Related U.S. Application Data
(63) Continuation-in-part of application No. PCT/JP2011/002625, filed on May 11, 2011.

(30) Foreign Application Priority Data
May 21, 2010 (JP) 2010-117521

(51) Int. Cl. G21C 9/016

(52) U.S. Cl. CPC G21C 9/016
USPC 376/280

(57) ABSTRACT

According to an embodiment, a nuclear reactor containment vessel is provided with a device for holding a molten material of the reactor core and with spacers. The device is installed on the pedestal floor. A holding container which is open upward and a water supply container which is provided below the holding container are provided inside the outer peripheral surface. A water supply flow path extends to the water supply container from the gap between the inner surface of the pedestal side wall and the outer peripheral surface of the device for holding a molten material of the reactor core. The spacers are engaged with the upper end of an outer riser extend between the outside of the outer riser and the inner surface of the pedestal side wall, and prevent the eccentricity of the device.

### CROSS REFERENCES TO RELATED APPLICATIONS

This application is a continuation-in-part (CIP) application based upon the International Application PCT/JP2011/002625, the International Filing Date of which is May 11, 2011, the entire content of which is incorporated herein by reference, and claims the benefit of priority from the prior Japanese Patent Application No. 2010-117521, filed in the Japanese Patent Office on May 21, 2010, the entire content of which is incorporated herein by reference.

### FIELD

Embodiments described herein relate to a nuclear reactor containment vessel that stores a reactor vessel in which a reactor core is stored.

### BACKGROUND

In a water-cooled nuclear reactor, when cooling water is lost due to the stopping of supply of water into a reactor pressure vessel or the rupture of a pipe connected to the reactor pressure vessel, there is the possibility that the reactor core will be exposed as the water level of the nuclear reactor goes down, and cooling cannot be conducted sufficiently. In case such an accident occurs, the water-cooled nuclear reactor is designed to automatically start an emergency shutdown of the reactor in response to a water-level dropping signal and cool the reactor core by injecting coolant through an emergency core cooling system (ECCS) and flooding the reactor core with water, thereby preventing a core meltdown accident from occurring.

However, the following accident could happen, even though the possibility is very low: the emergency core cooling system does not work, and other devices for injecting water into the reactor core become unavailable. In such a case, the reactor core becomes exposed as the water level of the nuclear reactor goes down, and cooling cannot be carried out sufficiently; due to decay heat, which continues to be generated even after the shutdown of the nuclear reactor, the temperatures of the fuel rods rise, possibly and ultimately leading to core meltdown.

When such an accident occurs, high-temperature reactor-core molten materials would fall down into the lower part of the reactor pressure vessel, and melt and penetrate the lower mirror head of the reactor pressure vessel, and eventually fall down onto a floor inside the containment vessel. The reactor-core molten materials heat up the concrete that covers the containment vessel floor. As the contact surface rises in temperature, the reactor-core molten materials react with the concrete, generating a large amount of non-condensable gases, such as carbon dioxide and hydrogen, and melting and eroding the concrete. The generated non-condensable gases help to increase the pressure inside the containment vessel, and pose a risk of damaging the nuclear reactor containment vessel. As the concrete is melted and eroded, the boundary of the containment vessel could be damaged, and the structural strength of the containment vessel could be lowered. Consequently, if the reaction of the reactor-core molten materials with the concrete continues, the containment vessel would end up being damaged, raising the risk that radioactive materials inside the containment vessel will be released into the external environment.

To suppress the reaction of the reactor-core molten materials with the concrete, the reactor-core molten materials need to be cooled down so that the temperature of the contact surface of the reactor-core molten materials' bottom portions with the concrete is lower than or equal to the erosion temperature (or 1,500 K or lower in the case of typical concrete); or it is necessary to prevent the reactor-core molten materials from coming in direct contact with the concrete. In case the reactor-core molten materials fall down, various measures have been proposed, including a core catcher among other things. The core catcher is a system designed to receive the falling down reactor-core molten materials with heat resisting materials and cool the reactor-core molten materials by working together with a water injection means.

Even after cooling water is injected onto an upper surface of the reactor-core molten materials that have fallen down to the nuclear reactor containment vessel's floor, the temperatures of the reactor-core molten materials' bottom portions remain high due to decay heat if the amount of heat removed is small at the bottom portions of the reactor-core molten materials, raising the possibility that a process of eroding the concrete of the containment vessel floor cannot be stopped. Here, there may be a method of starting cooling from bottom surfaces of the reactor-core molten materials.

When water is injected to the reactor-core molten materials to carry out cooling with the help of boiling water on top surfaces of the reactor-core molten materials, the process of cooling only the top surfaces is not sufficient to cool the bottom portions of the reactor-core molten materials if the reactor-core molten materials accumulated are thick. As a result, the floor space needs to be expanded, and the reactor-core molten materials accumulated need to be made thin enough to be cooled. However, given the structural design of the containment vessel, it is difficult to sufficiently expand the floor space.

For example, the decay heat of typical reactor-core molten materials is about 1% of rated thermal power. In the case of a reactor with a rated thermal power of 4,000 MW, the amount of heat generated is about 40 MW. The amount of boiling heat transfer on the top surfaces varies according to the state of reactor-core molten materials' top surface. However, when the amount is small, the heat flux is expected to be about 0.4 MW/m². In this case, if the amount of heat generated from the reactor-core molten materials is removed only by heat transfer of the top surfaces, the floor space needs to be about 100 m² (or a circle diameter of 11.3 m). Given the conventional structures of containment vessels, it is difficult to secure the above floor space.

Another method may be to provide a cooling water duct below a floor face on which reactor-core molten materials are accumulated, and remove heat from the bottom surfaces of the reactor-core molten materials by introducing cooling water into the duct. When a top surface of the duct turns into a heated surface, the following problem arises: vapor voids that have emerged on the heated surface remain along the heated surface, interfering with heat transfer as a steam film is formed. Accordingly, there may be a method of making a heat transfer surface incline to discharge the generated voids quickly from the cooling duct.

As a background art, the prior art disclosed in Japanese Patent Application Laid-Open Publication No. 2007-232529 is known.

When a reactor-core molten material holding device is placed in a containment vessel of an existing plant, a method of sequentially assembling parts on an installation site is expected to be used. When a reactor-core molten material holding device is placed in a new plant, it may be desirable that a modular construction method be employed. The modular construction method is a typical construction method in the field of architecture. According to the modular construction method, for example, the reactor-core molten material holding device is produced integrally near a manufacturing facility or a construction site, and then is lifted up by a crane before being placed on the pedestal floor, which is the installation site. Such a modular construction method is beneficial in shortening the construction period of the entire plant, and in terms of workability and construction safety, as well as quality control of the reactor-core molten material holding device.

However, if the reactor-core molten material holding device is just placed on the pedestal floor, the reactor-core molten material holding device could move on the pedestal floor when airplane crash accidents or vibration caused by earthquakes take place. In such a case, the cross-sectional shape of a water injection ducts extending between the reactor-core molten material holding device and the pedestal side wall could become uneven in a circumferential direction. As a result, the amounts of flowing water distributed into a plurality of cooling ducts could drastically change.

Therefore, the object of the present invention is to suppress a change in the position of the reactor-core molten material holding device after the reactor-core molten material holding device is installed.

### BRIEF DESCRIPTION OF THE DRAWINGS

The features and advantages of the present invention will become apparent from the discussion hereinbelow of specific, illustrative embodiments thereof presented in conjunction with the accompanying drawings, in which:

FIG. 1 is an enlarged partially perspective view of a first embodiment of a reactor-core molten material holding device of the present invention;

FIG. 2 is a vertical cross-sectional view of a containment vessel that stores the first embodiment of the reactor-core molten material holding device of the present invention;

FIG. 3 is a vertical cross-sectional view of a nearby area of the first embodiment of the reactor-core molten material holding device according to the present invention;

FIG. 4 is a top view of a water channel assembly according to the first embodiment of the reactor-core molten material holding device of the present invention;

FIG. 5 is a perspective view of a water channel and a heat-resistance material according to the first embodiment of the reactor-core molten material holding device of the present invention;

FIG. 6 is a perspective view showing a second embodiment of a reactor-core molten material holding device of the present invention along with a containment vessel, partly showing a cross-section view thereof;

FIG. 7 is a perspective view showing a third embodiment of a reactor-core molten material holding device of the present invention along with a containment vessel, partly showing a cross-section view thereof;

FIG. 8 is a perspective view showing a fourth embodiment of a reactor-core molten material holding device of the present invention along with a containment vessel, partly showing a cross-section view thereof;

FIG. 9 is a top view showing a fifth embodiment of a reactor-core molten material holding device of the present invention, along with a horizontal cross-sectional view of a containment vessel;

FIG. 10 is a top view showing a modified example of the fifth embodiment of the reactor-core molten material holding device of the present invention, along with a cross-sectional view of a containment vessel;

FIG. 11 is a vertical cross-sectional view of a nearby area of a plate-like projecting object according to a modified example of the fifth embodiment of the reactor-core molten material holding device of the present invention;

FIG. 12 is a perspective view of a nearby area of a plate-like projecting object according to a modified example of the fifth embodiment of the reactor-core molten material holding device of the present invention;

FIG. 13 is a vertical cross-sectional view showing a nearby area of a plate-like projecting object during a lifting down operation according to a modified example of the fifth embodiment of the reactor-core molten material holding device of the present invention;

FIG. 14 is a perspective view showing a portion of a sixth embodiment of a reactor-core molten material holding device of the present invention along with a containment vessel, partly showing a cross-section view thereof;

FIG. 15 is a perspective view of a portion of the sixth embodiment of the reactor-core molten material holding device of the present invention;

FIG. 16 is a horizontal cross-sectional view showing a portion of the sixth embodiment of the reactor-core molten material holding device of the present invention, as well as a cross-sectional surface of a containment vessel;

FIG. 17 is a perspective view showing a portion of a seventh embodiment of a reactor-core molten material holding device of the present invention along with a containment vessel, partly showing a cross-section view thereof;

FIG. 18 is a perspective view showing a portion of the seventh embodiment of the reactor-core molten material holding device of the present invention along with a containment vessel;

FIG. 19 is a perspective view showing a portion of an eighth embodiment of a reactor-core molten material holding device of the present invention along with a containment vessel, partly showing a cross-section view thereof;

FIG. 20 is a perspective view showing a portion of the eighth embodiment of the reactor-core molten material holding device of the present invention along with a containment vessel;

FIG. 21 is a perspective view showing a portion of a ninth embodiment of a reactor-core molten material holding device of the present invention along with a containment vessel, partly showing a cross-section view thereof;

FIG. 22 is a perspective view showing a portion of the ninth embodiment of the reactor-core molten material holding device of the present invention along with a containment vessel;

FIG. 23 is a perspective view showing a tenth embodiment of a reactor-core molten material holding device of the present invention along with a containment vessel, partly showing a cross-section view thereof;

FIG. 24 is a vertical cross-sectional view of a nearby area of a reactor-core molten material holding device according to a modified example of the tenth embodiment of the reactor-core molten material holding device of the present invention;

FIG. 25 is a horizontal cross-sectional view of a nearby area of a pedestal floor according to an eleventh embodiment of a reactor-core molten material holding device of the present invention;

FIG. 26 is a vertical cross-sectional view taken along arrows XXVI-XXVI of FIG. 25, as well as a vertical cross-sectional view showing a nearby area of the eleventh embodiment of the reactor-core molten material holding device of the present invention;

FIG. 27 is a horizontal cross-sectional view of a nearby area of a pedestal floor according to a twelfth embodiment of a reactor-core molten material holding device of the present invention;

FIG. 28 is a vertical cross-sectional view taken along arrows XXVIII-XXVIII of FIG. 27, as well as a vertical cross-sectional view showing a nearby area of the twelfth embodiment of the reactor-core molten material holding device of the present invention;

FIG. 29 is a horizontal cross-sectional view of a nearby area of a pedestal floor according to a thirteenth embodiment of a reactor-core molten material holding device of the present invention;

FIG. 30 is a vertical cross-sectional view taken along arrows XXX-XXX of FIG. 29, as well as a vertical cross-sectional view showing a nearby area of the thirteenth embodiment of the reactor-core molten material holding device of the present invention;

FIG. 31 is a perspective view showing a cross-sectional plane of a portion of a nearby area of a pedestal floor during a lifting down operation according to a fourteenth embodiment of a reactor-core molten material holding device of the present invention;

FIG. 32 is a perspective view showing a cross-sectional plane of a portion of a nearby area of the fourteenth embodiment of the reactor-core molten material holding device of the present invention; and

FIG. 33 is a perspective view of a nearby area of a supporting plate according to the fourteenth embodiment of the reactor-core molten material holding device of the present invention.

### DETAILED DESCRIPTION

According to an aspect of the present invention, there is provided a nuclear reactor containment vessel that stores a reactor vessel in which a reactor core is stored, the vessel comprising: a pedestal floor which is provided below the reactor vessel; a pedestal side wall which rises vertically from the pedestal floor and in which a water injection outlet from which cooling water is released is formed; a reactor-core molten material holding device which includes: a holding container that is placed on the pedestal floor and has an outer circumferential surface that faces an inner surface of the pedestal side wall across a gap and is opened upward at an inner side of the outer circumferential surface, and a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed; and decentering prevention bodies which are disposed at least at three locations that are different in terms of circumferential-direction position of the outer circumferential surface and between the outer circumferential surface and the inner surface of the pedestal side wall.

According to another aspect of the present invention, there is provided a nuclear reactor containment vessel that stores a reactor vessel in which a reactor core is stored, the vessel comprising: a pedestal floor which is provided below the reactor vessel; a pedestal side wall which rises vertically from the pedestal floor and in which a water injection outlet from which cooling water is released is formed; a reactor-core molten material holding device which includes: a holding container that is placed on the pedestal floor and has an outer circumferential surface that faces an inner surface of the pedestal side wall across a gap and is opened upward at an inner side of the outer circumferential surface, and a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed; and a flange which is fixed to a lower end of the reactor-core molten material holding device and whose vertical-direction projected area is larger than the outer circumferential surface.

According to yet another aspect of the present invention, there is provided a nuclear reactor containment vessel that stores a reactor vessel in which a reactor core is stored, the vessel comprising: a pedestal floor which is provided below the reactor vessel; a pedestal side wall which rises vertically from the pedestal floor and in which a water injection outlet from which cooling water is released is formed; and a reactor-core molten material holding device which includes: a holding container that is placed on the pedestal floor and has an outer circumferential surface that faces an inner surface of the pedestal side wall across a gap and is opened upward at an inner side of the outer circumferential surface, and a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed, wherein a dent is formed either on the pedestal floor or a lower surface of the reactor-core molten material holding device, and a projection, which is fitted into the dent, is formed either on a lower surface of the reactor-core molten material holding device or on the pedestal floor.

According to yet another aspect of the present invention, there is provided a nuclear reactor containment vessel that stores a reactor vessel in which a reactor core is stored, the vessel comprising: a pedestal floor which is provided below the reactor vessel; a pedestal side wall which rises vertically from the pedestal floor and in which a water injection outlet from which cooling water is released is formed; a reactor-core molten material holding device which includes: a holding container that is placed on the pedestal floor and has an outer circumferential surface that faces an inner surface of the pedestal side wall across a gap and is opened upward at an inner side of the outer circumferential surface, and a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed; and a tubular supporting structure which rises from the pedestal floor along the outer circumferential surface and on which a notch is formed on an upper end thereof; and a rotation prevention projecting portion which is fixed to the reactor-core molten material holding device, and which projects from the outer circumferential surface toward the pedestal side wall to engage with the notch.

According to the embodiments, it is possible to suppress the change in the position of the reactor-core molten material holding device after the reactor-core molten material holding device is installed.

Embodiments of a reactor-core molten material holding device of the present invention will be described with reference to the accompanying drawings. The same, or similar, components are represented by the same reference symbols, and the duplicate descriptions are omitted.

### First Embodiment

FIG. 2 is a vertical cross-sectional view of a containment vessel that stores a first embodiment of a reactor-core molten material holding device of the present invention.

A reactor core 51 is stored in a reactor pressure vessel 1. The reactor pressure vessel 1 is placed inside a containment vessel 2. The containment vessel 2 includes a pedestal floor 12, and a cylindrical pedestal side wall 11 which extends upwards from the pedestal floor 12.

The reactor pressure vessel 1 is supported by the pedestal side wall 11. The space, which is positioned below the reactor pressure vessel 1 and enclosed by the pedestal floor 12 and the pedestal side wall 11, is referred to as a lower drywell 7. That is, the reactor pressure vessel 1 is positioned above the lower drywell 7. Inside the containment vessel 2, a suppression pool 4 is so formed as to encircle an outer circumferential surface of the pedestal side wall 11.

In the lower drywell 7, which is positioned below the reactor pressure vessel 1, a reactor-core molten material holding device 9 is provided. Between the reactor-core molten material holding device 9 and the reactor pressure vessel 1, a sump floor 8 is provided.

The containment vessel 2 also includes a water tank 5. Water injection pipes 16 extend from the water tank 5 to the reactor-core molten material holding device 9. In the middle of the water injection pipes 16, a valve 52 is provided. Furthermore, the containment vessel 2 includes a containment vessel cooler 6. The containment vessel cooler 6 includes a pipe that extends from an end portion thereof, which is opened to the drywell, to the water tank 5 via a heat exchanger submerged in water. The containment vessel cooler 6 is a passive containment vessel cooling system, a drywell cooler, or the like.

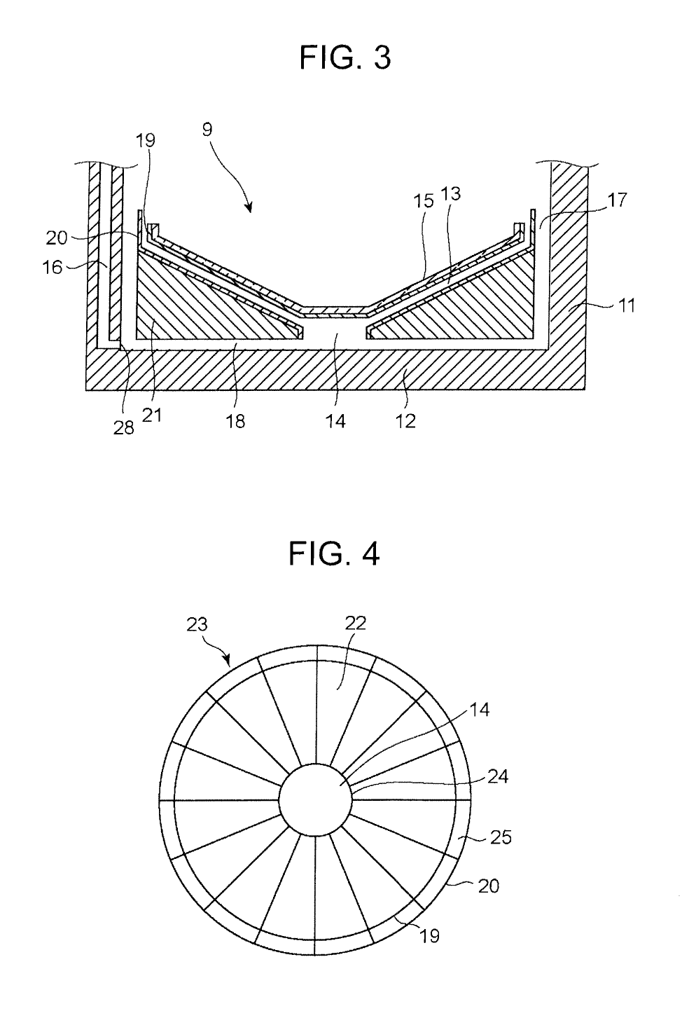

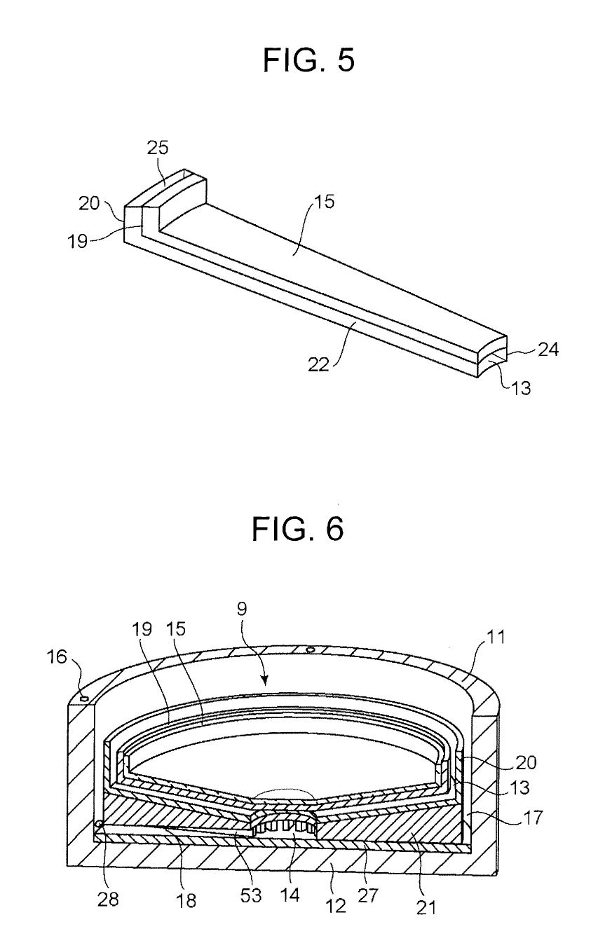

FIG. 3 is a vertical cross-sectional view of a nearby area of the reactor-core molten material holding device according to the present embodiment. FIG. 4 is a top view of a water channel assembly according to the present embodiment. FIG. 5 is a perspective view of a water channel and a heat-resistance material according to the present embodiment.

The reactor-core molten material holding device 9 is placed on the pedestal floor 12. The reactor-core molten material holding device 9 includes a supporting base 21, a water supply container 14, and water channels 22, and heat-resistance materials 15. The outer diameter of the supporting base 21 is smaller than the inner diameter of the pedestal side wall 11. The supporting base 21 is placed on the pedestal floor 12. The top surface of the supporting base 21 is so formed as to have a shape that is created by cutting off a lower end portion of a conical surface that opens upwards. In a central portion of the supporting base 21, the water supply container 14 is placed. The water supply container 14 is formed in the shape of a hollow circular disc. Between the outer circumferential surface of the supporting base 21 and the inner surface of the pedestal side wall 11, a water supply duct vertical section 17 is formed.

At the lower end of the supporting base 21, for example, legs are so provided as to radially extend from the water supply container 14. Between the legs, water supply duct horizontal sections 18 are formed. The lower end of the water supply duct vertical section 17 communicates with the water supply duct horizontal sections 18. The upper end of the water supply duct vertical section 17 is open. The opposite ends of the water supply duct horizontal sections 18 from the communicating portions with the water supply duct vertical section 17 communicate with the water supply container 14. The water injection pipes 16 are opened in a water injection pipe outlets 28, which are positioned near the pedestal floor 12.

On the top surface of the supporting base 21, a water channel assembly 23 is fixed. The water channel assembly 23 is made by closely arranging hollow water channels 22, which have inclined heat transfer surfaces, in a circumferential direction. The water channel assembly 23 as a whole is formed substantially in the shape of a cone that is opened upwards. The water channel assembly 23 is a combination of a plurality of water channels 22, which radially extend around the water supply container 14. Each water channel 22 is in a fan shape when being projected. The water channels 22 are in contact with each other without any gap therebetween.

The water channels 22 are so formed as to be hollow. Lower inlets 24 of the water channels 22, which are connected to the water supply container 14, are opened. Outer circumferential portions of the water channels 22 rise vertically, and their upper ends are opened at upper outlets 25. As a result, cooling water ducts 13 are so formed as to spread radially and rise from the water supply container 14 toward the pedestal side wall 11 with some degree of inclination and rise vertically in the outer circumferential portions. Of the water channel assembly 23, an outer portion that encircles a portion where the cooling water duct 13 rises vertically is referred to as an outer riser 20, and an inner portion that faces the portion where the cooling water duct 13 rises vertically as an inner riser 19. On the top surface of the water supply container 14, the top surface of the water channel assembly 23, and the surface of the inner riser 19 that heads to the center thereof, a heat-resistance material 15 is so disposed as to cover the entire surfaces.

When a core meltdown accident happens, and when reactor-core molten materials penetrate the lower head 3 of the reactor pressure vessel 1, the reactor-core molten materials fall down onto the reactor-core molten material holding device 9. Immediately after the reactor-core molten materials fall down, the valve 52 is opened. The cooling water in the water tank 5 falls down due to the force of gravity, and is supplied to the reactor-core molten material holding device 9 via the water injection pipes 16. The cooling water that has fallen down in the water injection pipes 16 is released out of the water injection pipe outlets 28, passes through the water supply duct horizontal sections 18, and then reaches the water supply container 14. The cooling water that has reached the water supply container 14 flows into the cooling water ducts 13.

For example, the valve 52 is opened by a signal that is designed to detect damage to the lower head 3 of the reactor pressure vessel 1. The signal that is designed to detect damage to the lower head 3 of the reactor pressure vessel 1 may be a signal associated with a rise in the temperature of the lower head, or a rise in the pedestal ambient temperature, for example. In that manner, the initial supply of water to the water supply container 14 takes place immediately after the falling down of reactor-core molten materials, and cooling water is supplied to the cooling water ducts 13.

The water that has been supplied to the cooling water ducts 13 spills out of the upper end opening portion of a riser portion sandwiched between the inner riser 19 and the outer riser 20 into a container portion of the reactor-core molten material holding device 9 that holds reactor-core molten materials. Then, the whole reactor-core molten material holding device 9 is submerged in water.

After the initial injection of water is completed, the water that has spilled into the container portion of the reactor-core molten material holding device 9 that holds reactor-core molten materials is supplied to the water supply container 14, as part of natural circulation caused by boiling in the cooling water ducts 13, via a supply water duct in which the water supply duct vertical section 17 and the water supply duct horizontal sections 18 are combined.

The steam generated by cooling of the reactor-core molten materials is condensed by the containment vessel cooler 6, which is positioned above the containment vessel 2, and then the condensed water returns to the water tank 5. In this manner, as the water circulates naturally, the cooling of reactor-core molten materials continues. The heat of high-temperature reactor-core molten materials is transferred to the heat-resistance materials 15, and then to the cooling water via the water channels 22. In this manner, the reactor-core molten materials are cooled.

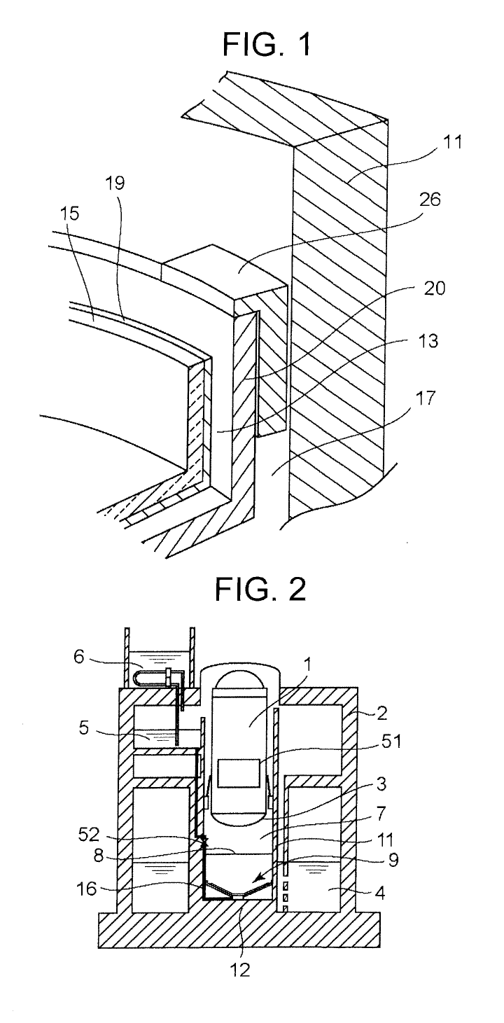

FIG. 1 is an enlarged partially perspective view of the reactor-core molten material holding device according to the present embodiment.

Furthermore, the reactor-core molten material holding device 9 of the present embodiment includes spacers 26. Each of the spacers 26 includes a portion that hangs on the upper end of the outer riser 20, and a portion that is fixed to the portion hanging on the upper end of the outer riser 20 and extends in the gap between the outer surface of the outer riser 20 and the inner surface of the pedestal side wall 11. As for the spacer 26, the radial-direction width of the portion that is fixed to the portion hanging on the upper end of the outer riser 20 and extends in the gap between the outer surface of the outer riser 20 and the inner surface of the pedestal side wall 11 is substantially equal to the width of the gap between the outer surface of the outer riser 20 and the inner surface of the pedestal side wall 11.

The spacers 26 are placed at least at three locations in the circumferential direction of the reactor-core molten material holding device 9 in such a way that the center of the reactor-core molten material holding device 9 is positioned inside a triangle whose vertices are at the above three locations. The spacers 26 may be fixed to the outer riser 20 or to the pedestal side wall 11 with bolts or the like, which are not shown in the diagram.

The parts of the reactor-core molten material holding device 9 of the present embodiment except the spacers 26 are assembled outside the containment vessel 2, which is the installation site. The parts of the reactor-core molten material holding device 9 are assembled in a manufacturing facility, for example. The parts of reactor-core molten material holding device 9 that are assembled integrally except the spacers 26 are lifted up by a crane after the pedestal floor 12 and the pedestal side wall 11 of the containment vessel 2 are formed, and placed onto the pedestal floor 12. Then, the spacers 26 are placed at predetermined positions, and the reactor-core molten material holding device 9 is completed as a result. Then, the reactor pressure vessel 1 and the like are installed.

In the reactor-core molten material holding device 9, even when airplane crash accidents or vibration caused by earthquake and so on take place, the spacers 26 attached to the reactor-core molten material holding device 9 come in contact with the pedestal side wall 11. Therefore, it is possible to decrease the possibility that the position of the reactor-core molten material holding device is shifted. That is, the wedge-shaped spacers 26 are additionally placed in the water supply duct vertical section 17, which is formed in the gap of the pedestal side wall 11. Therefore, the spacers 26 and the like function as a mechanism for suppressing a change in the position of the reactor-core molten material holding device 9.

The reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device 9 does not move significantly even when airplane crash accidents or vibration caused by earthquake and so on take place. That is, after the reactor-core molten material holding device 9 is installed, the change in the position of the reactor-core molten material holding device 9 is suppressed. As a result, it is possible to suppress the amounts of flowing cooling water distributed into the plurality of cooling water ducts 13 from changing wildly.

According to the present embodiment, first the parts of the reactor-core molten material holding device 9 except the spacers 26 are lifted up and down into the space encircled by the pedestal side wall 11. During the lifting down operation, between the parts of the reactor-core molten material holding device 9 except the spacers 26 and the pedestal side wall 11, there is a gap that is equivalent to the width of the water supply duct vertical section 17. Consequently, during the lifting down operation, the parts of the reactor-core molten material holding device 9 except the spacers 26 are less likely to interfere with the pedestal side wall 11, and it becomes easier to carry out the lifting down operation.

As a working space after the parts of the reactor-core molten material holding device 9 except the spacers 26 are placed, only a limited space is left in an upper area. However, according to the position change suppression mechanism of the present embodiment, after the parts of the reactor-core molten material holding device 9 except the spacers 26 are placed, the spacers 26 are placed therein from the upper area. In this manner, the position change suppression mechanism can be formed easily.

In that manner, the modular construction method is employed. Therefore, it is possible to shorten the construction period, and make improvements in terms of workability and construction safety, as well as in the quality of the reactor-core molten material holding device 9. Furthermore, since an existing pedestal structure is employed, there is no need to design a new pedestal structure.

### Second Embodiment

FIG. 6 is a perspective view showing a second embodiment of a reactor-core molten material holding device of the present invention along with a containment vessel, partly showing a cross-section view thereof.

In the reactor-core molten material holding device 9 of the present embodiment, a flange 27 is provided at a lower end thereof. The flange 27 is a circular disc whose outer diameter is substantially equal to the inner diameter of the pedestal side wall 11. For example, the flange 27 is fixed to the supporting base 21 as its top surface is welded to lower ends of the legs 53.

The flange 27 is made up of steel materials, ferro-concrete, a structure in which steel sheets are applied to concrete surfaces, or the like. According to the present embodiment, an outer circumferential portion of the flange 27 functions as the position change suppression mechanism of the reactor-core molten material holding device 9.

Water injection pipe outlets 28, which are outlets of the water injection pipes 16 provided inside the pedestal side wall 11, are disposed above the flange 27. Therefore, the water injection pipe outlets 28 are not closed by, for example, the flange 27 or any other portion of the reactor-core molten material holding device 9. Therefore, when the reactor-core molten material holding device 9 is installed, the position of the reactor-core molten material holding device 9 is easily determined. Moreover, even when the reactor-core molten material holding device 9 rotates in the horizontal direction due to airplane crash accidents or vibration caused by earthquakes and so on, the water injection pipe outlets 28 remain open to the water supply ducts. Therefore, the possibility is low that the injection of water is hampered at the time of a core meltdown accident.

In that manner, according to the present embodiment, the reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into the plurality of cooling water ducts 13 from changing wildly.

Furthermore, according to the present embodiment, unlike the first embodiment, there is no need to attach spacers 26 (See FIG. 1) and the like after most portions of the reactor-core molten material holding device 9 are placed onto the pedestal floor 12. Therefore, a workload at the installation site is reduced. Furthermore, since an existing pedestal structure is employed, there is no need to design a new pedestal structure.

### Third Embodiment

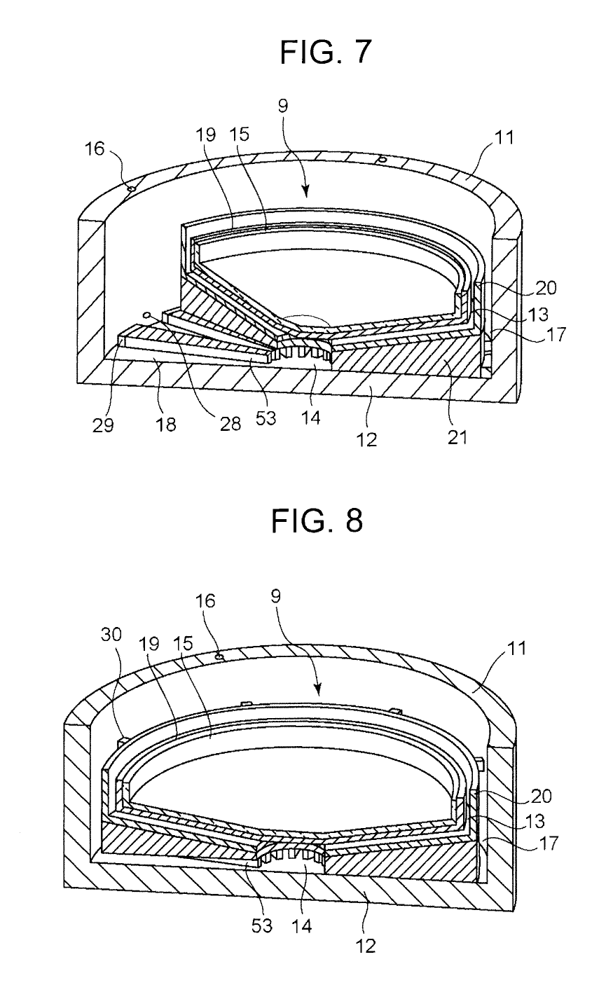

FIG. 7 is a perspective view showing a third embodiment of a reactor-core molten material holding device of the present invention along with a containment vessel, partly showing a cross-section view thereof.

The reactor-core molten material holding device 9 of the present embodiment includes projecting objects 29, which are fixed to the legs 53 provided at the lower end. The legs 53 are so formed as to be in fan shapes, and provided at the lower end of the reactor-core molten material holding device 9. A plurality of legs 53 are disposed radially from the outer circumference of the water supply container 14, and spaced out from each other in the circumferential direction.

Between the adjacent legs 53, a water supply duct horizontal section 18 is formed. The water injection pipes 16 are opened at the water injection pipe outlets 28, which are formed on the pedestal side wall 11. The reactor-core molten material holding device 9 is so placed that each of the water injection pipe outlets 28 is positioned between the adjacent projecting objects 29 of the legs 53.

The projecting objects 29 project from the outer circumferential sides of the legs 53 toward the pedestal side wall 11. The projection length of the projecting objects 29 from the legs 53 is substantially equal to the radial-direction width of the water supply duct vertical section 17. The projecting objects 29 may be formed integrally with the legs 53. Alternatively, the projecting objects 29 may be produced separately from the legs 53, and then fixed to the legs 53.

The projecting objects 29 fixed to the legs 53 are made up of steel materials, ferro-concrete, a structure in which steel sheets are applied to concrete surfaces, or the like. The water injection pipe outlets 28, which are outlets of the water injection pipes 16 provided inside the pedestal side wall 11, are disposed above the projecting objects 29 so that, even when the reactor-core molten material holding device 9 rotates, the water injection pipe outlets 28 are not blocked by the projecting objects 29. There is no need to provide projecting objects 29 on all the inlet portions of the water supply duct horizontal sections 18. The number of projecting objects 29 provided may be increased or decreased appropriately according to the earthquake-resistant design.

According to the present embodiment, the projecting objects 29 fixed to the legs 53 function as the position change suppression mechanism of the reactor-core molten material holding device 9.

In that manner, according to the present embodiment, the reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

Furthermore, according to the present embodiment, unlike the first embodiment, there is no need to attach spacers 26 (See FIG. 1) and the like after most portions of the reactor-core molten material holding device 9 are placed onto the pedestal floor 12. Therefore, a workload at the installation site is reduced. Furthermore, since an existing pedestal structure is employed, there is no need to design a new pedestal structure.

### Fourth Embodiment

FIG. 8 is a perspective view showing a fourth embodiment of a reactor-core molten material holding device of the present invention along with a containment vessel, partly showing a cross-section view thereof.

The reactor-core molten material holding device 9 of the present embodiment includes projecting objects 30, which are fixed to the outer surface of the outer riser 20. The projecting objects 30 project from the outer surface of the outer riser 20 toward the pedestal side wall 11. The projection length of the projecting objects 30 from the outer surface of the outer riser 20 is substantially equal to the radial-direction width of the water supply duct vertical section 17. The projecting objects 30 are placed at least at three locations in the circumferential direction of the reactor-core molten material holding device 9 in such a way that the center of the reactor-core molten material holding device 9 is positioned inside a triangle whose vertices are at the three locations.

According to the present embodiment, the projecting objects 30 function as the position change suppression mechanism of the reactor-core molten material holding device 9. The projecting objects 30 may be fixed to the pedestal side wall 11. The number of projecting objects 30 may be increased or decreased appropriately according to the earthquake-resistant design.

In that manner, according to the present embodiment, the reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

Furthermore, according to the present embodiment, unlike the first embodiment, there is no need to attach spacers 26 (See FIG. 1) and the like after most portions of the reactor-core molten material holding device 9 are placed onto the pedestal floor 12. Therefore, a workload at the installation site is reduced. Furthermore, since an existing pedestal structure is employed, there is no need to design a new pedestal structure.

### Fifth Embodiment

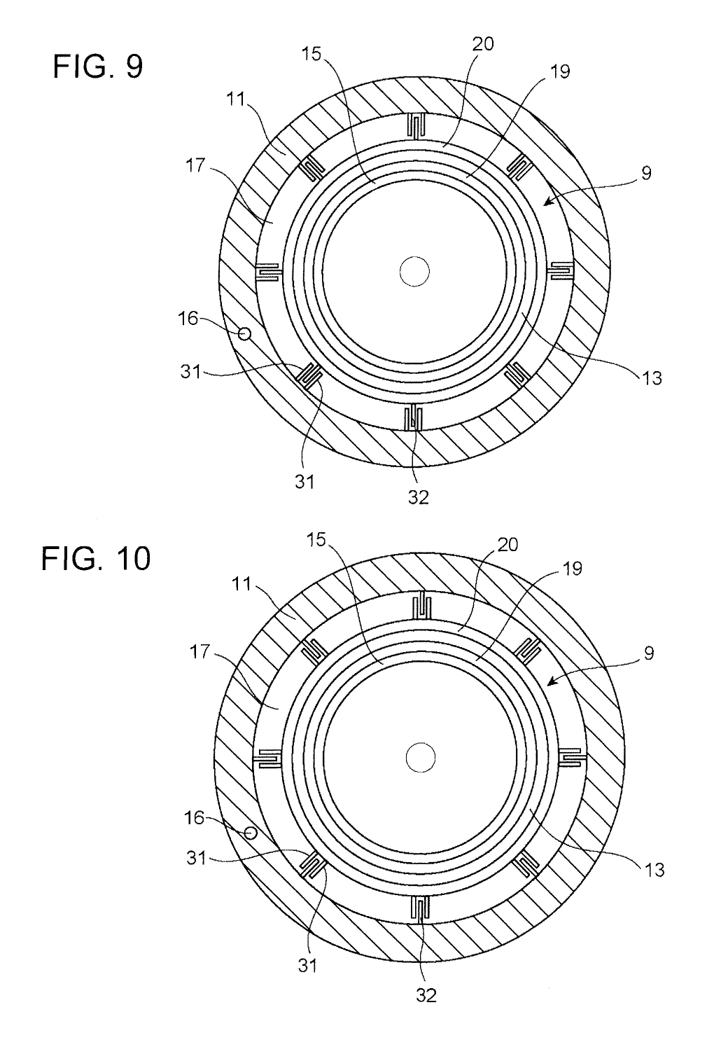

FIG. 9 is a top view showing a fifth embodiment of a reactor-core molten material holding device of the present invention, along with a horizontal cross-sectional view of a containment vessel.

The reactor-core molten material holding device 9 of the present embodiment includes plate-like projecting objects 32, which are fixed to the outer surface of the outer riser 20. The plate-like projecting objects 32 project from the outer surface of the outer riser 20 toward the pedestal side wall 11. The projection length of the plate-like projecting objects 32 from the outer surface of the outer riser 20 is substantially equal to the radial-direction width of the water supply duct vertical section 17. The plate-like projecting objects 32 are placed at least at three locations in the circumferential direction of the reactor-core molten material holding device 9 in such a way that the center of the reactor-core molten material holding device 9 is positioned inside a triangle whose vertices are at the three locations. According to the present embodiment, eight plate-like projecting objects 32 are provided at regular intervals in the circumferential direction.

A pair of plate-like projecting objects 31 are fixed to the pedestal side wall 11 so as to correspond to each of the plate-like projecting objects 32 fixed to the outer riser 20. A pair of plate-like projecting objects 31 that are fixed to the pedestal side wall 11 are so provided that a plate-like projecting object 32 fixed to the outer riser 20 is sandwiched therebetween. The plate-like projecting objects 32 fixed to the outer riser 20, and the plate-like projecting objects 31 fixed to the pedestal side wall 11 are placed and positioned in such a way that, when the reactor-core molten material holding device 9 is placed on the pedestal floor 12, the plate-like projecting objects 32 and 31 are substantially equal in height to each other.

According to the present embodiment, after the pedestal side wall 11 is formed, the plate-like projecting objects 32 are fixed to predetermined locations. Parts of the reactor-core molten material holding device 9 except the plate-like projecting objects 31 fixed to the pedestal side wall 11 are assembled outside the containment vessel 2 (See FIG. 2). The parts of the reactor-core molten material holding device 9 are assembled in a manufacturing facility, for example. The reactor-core molten material holding device 9 that has been assembled outside is lifted up by a crane after the pedestal floor 12 and the pedestal side wall 11 of the containment vessel 2 are formed and the plate-like projecting objects 31 are fixed to the pedestal side wall 11. The reactor-core molten material holding device 9 is then installed onto the pedestal floor 12. After that, the reactor pressure vessel 1 and the like are installed.

According to the present embodiment, what is provided is a structure that interferes with and comes in contact with both the reactor-core molten material holding device 9 and the pedestal side wall 11 to suppress a change in the position. That is, the plate-like projecting objects 32 fixed to the outer riser 20, and the plate-like projecting objects 31 fixed to the pedestal side wall 11 function as the position change suppression mechanism of the reactor-core molten material holding device 9. Moreover, because each of the plate-like projecting objects 32 fixed to the outer riser 20 are sandwiched between the plate-like projecting objects 31 fixed to the pedestal side wall 11, the circumferential-direction rotation of the reactor-core molten material holding device 9 is suppressed.

FIG. 10 is a top view showing a modified example of the present embodiment, along with a cross-sectional view of a containment vessel.

In the modified example, a pair of plate-like projecting objects 31 is fixed to the outer rise 20 so as to correspond to each of the plate-like projecting objects 32 fixed to the pedestal side wall 11. A pair of the plate-like projecting objects 31 that are fixed to the outer riser 20 are so provided that a plate-like projecting object 32 fixed to the pedestal side wall 11 is sandwiched therebetween.

In the modified example, the plate-like projecting objects 31 fixed to the outer riser 20, and the plate-like projecting objects 32 fixed to the pedestal side wall 11 function as the position change suppression mechanism of the reactor-core molten material holding device 9. Moreover, because each of the plate-like projecting objects 32 fixed to the pedestal side wall 11 is sandwiched between the plate-like projecting objects 31 fixed to the outer riser 20, the circumferential-direction rotation of the reactor-core molten material holding device 9 is suppressed.

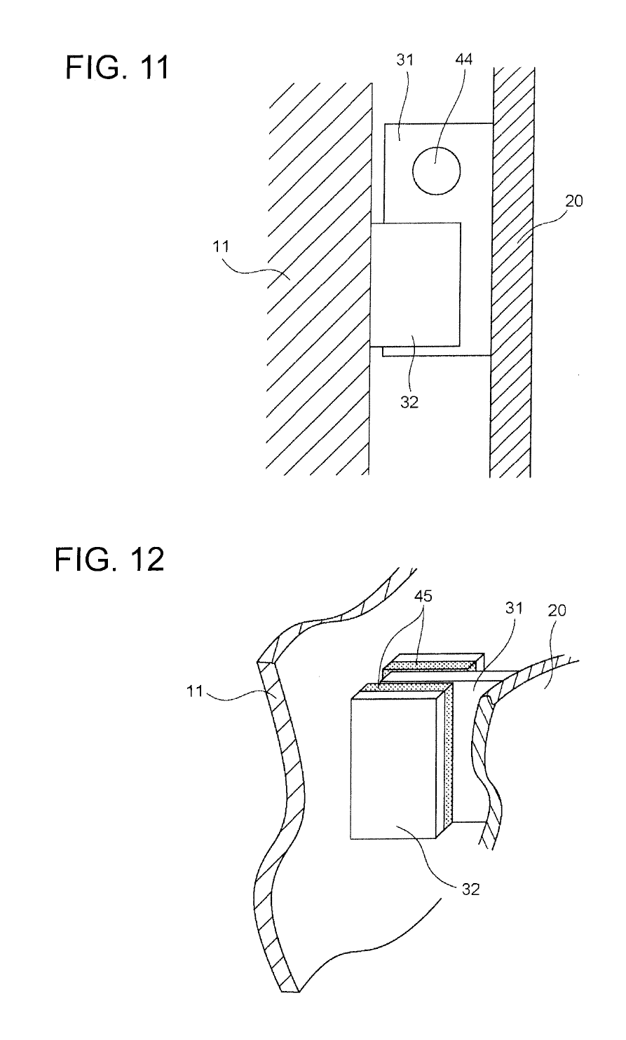

FIG. 11 is a vertical cross-sectional view of a nearby area of a plate-like projecting object according to another modified example of the present embodiment.

In the modified example, on the plate-like projecting object 31 fixed to the outer riser 20, a lift jig hole 44 is formed. The lift jig hole 44 penetrates the plate-like projecting object 31, which is fixed to the outer riser 20, in the plate-thickness direction.

The lift jig holes 44 are formed near the upper end portions of the plate-like projecting objects 31 fixed to the outer riser 20. The lift jig holes 44 are so designed as not to overlap with the plate-like projecting object 32 fixed to the pedestal side wall 11 at a time when the reactor-core molten material holding device 9 is placed on the pedestal floor 12. The plate-like projecting object 31 is fixed to an area near the upper end of the outer riser 20.

After wire ropes are inserted into the lift jig holes 44, the reactor-core molten material holding device 9 is lifted up by a crane and down into the pedestal side wall 11. Instead of the lift jig holes 44, hook-shaped notches may be formed as long as the notches are so formed that wire ropes can be put around.

In this manner, in the modified example, the reactor-core molten material holding device 9 is equipped with a lift jig function. Therefore, there is no need to carry out an additional operation of fixing lift jigs before the lifting down operation, as well as an operation of removing the jigs after the lifting down operation. Therefore, the number of components can be reduced. Moreover, it is possible to reduce the time and costs required for welding and other operations. Even in other embodiments, by providing a structure around which a wire rope can be put, it is possible to obtain similar advantageous effects to those in the present modified example.

Even after the reactor-core molten material holding device 9 is installed, a working space is secured above the reactor-core molten material holding device 9. Therefore, when the lift jig holes 44 are placed near the upper end of the outer riser 20, it is possible to easily remove the wire ropes after the installation of the reactor-core molten material holding device 9.

FIG. 12 is a perspective view of a nearby area of a plate-like projecting object according to another modified example of the present embodiment.

In the modified example, each of the plate-like projecting objects 32 fixed to the pedestal side wall 11 is equipped with a buffer 45. The buffer 45 is made of a material able to absorb an impact force, such as rubber or plate spring. The buffer 45 is provided on a surface of the plate-like projecting object 32 fixed to the pedestal side wall 11; the surface on which the buffer 45 is provided faces a plate-like projecting object 31 fixed to the outer riser 20.

In this manner, in the present modified example, a buffer 45 is provided in a portion where a fixed side and movable side of a position change suppression mechanism come in contact with each other. Therefore, even as the fixed and movable sides of the position change suppression mechanism come in contact with each other at a time when airplane crash accidents or vibration caused by earthquake and so on take place, the impact force generated at that time is mitigated by the buffer. Since the impact force is mitigated by the buffer 45, it is possible to suppress the position change suppression mechanism from being damaged or destroyed. As a result, an improvement is made in the reliability of the reactor-core molten material holding device 9.

The buffer may be provided at any locations as long as the buffers are positioned in portions where the fixed and movable sides of the position change suppression mechanism come in contact with each other. Moreover, in other embodiments, by providing a buffer in a portion where the fixed and movable sides of the position change suppression mechanism come in contact with each other, it is possible to obtain similar advantageous effects to those in the present modified example.

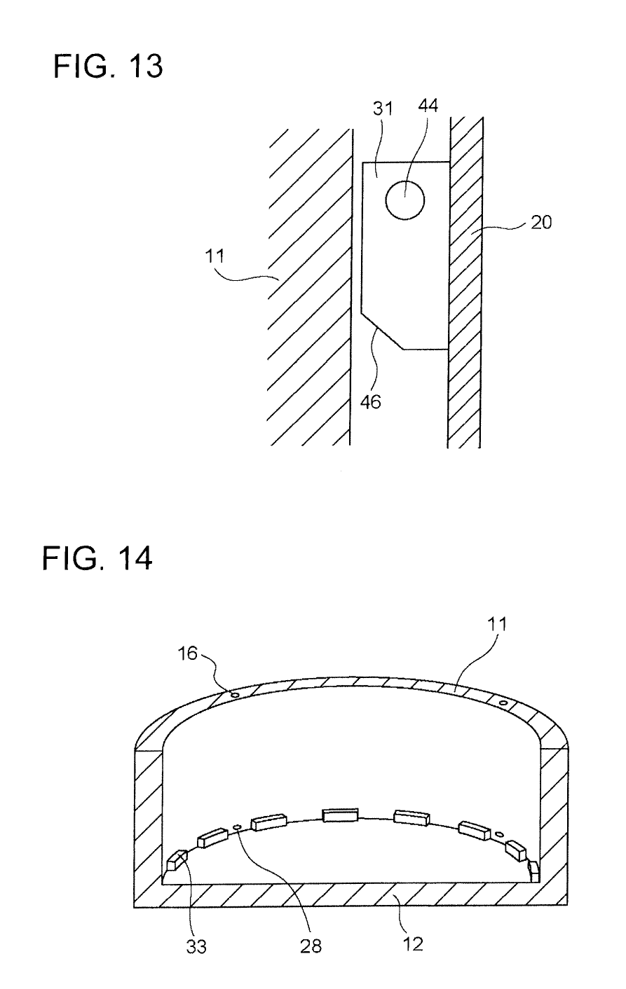

FIG. 13 is a vertical cross-sectional view showing a nearby area of a plate-like projecting object during a lifting down operation according to another modified example of the present embodiment.

In the modified example, at a lower end outer side of a plate-like projecting object 31 fixed to the pedestal side wall 11, a tapered portion 46 is formed. That is, in a portion where the fixed and movable sides of the position change suppression mechanism come in contact with each other, the tapered portion 46 is formed in a portion that is the first to pass through a nearby area of the fixed-side mechanism during a lifting down operation.

The narrowest portion that is the first to pass through a fixed portion in the position change suppression mechanism as the reactor-core molten material holding device 9 is lifted down is formed into a tapered structure. Therefore, the insertion performance of the contact portion is improved at a time when the reactor-core molten material holding device 9 is lifted down. Because the insertion performance of the contact portion at a time when the reactor-core molten material holding device 9 is lifted down is improved, it is possible to easily install the reactor-core molten material holding device 9 and make improvements in terms of workability. Moreover, even in other embodiments, by forming a tapered portion in a portion that is the first to pass through a nearby area of the fixed-side mechanism during a lifting down operation in a portion where the fixed and movable sides of the position change suppression mechanism come in contact with each other, it is possible to obtain similar advantageous effects to those in the present modified example.

In this manner, in the present embodiment and in the modified examples thereof, the reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

### Sixth Embodiment

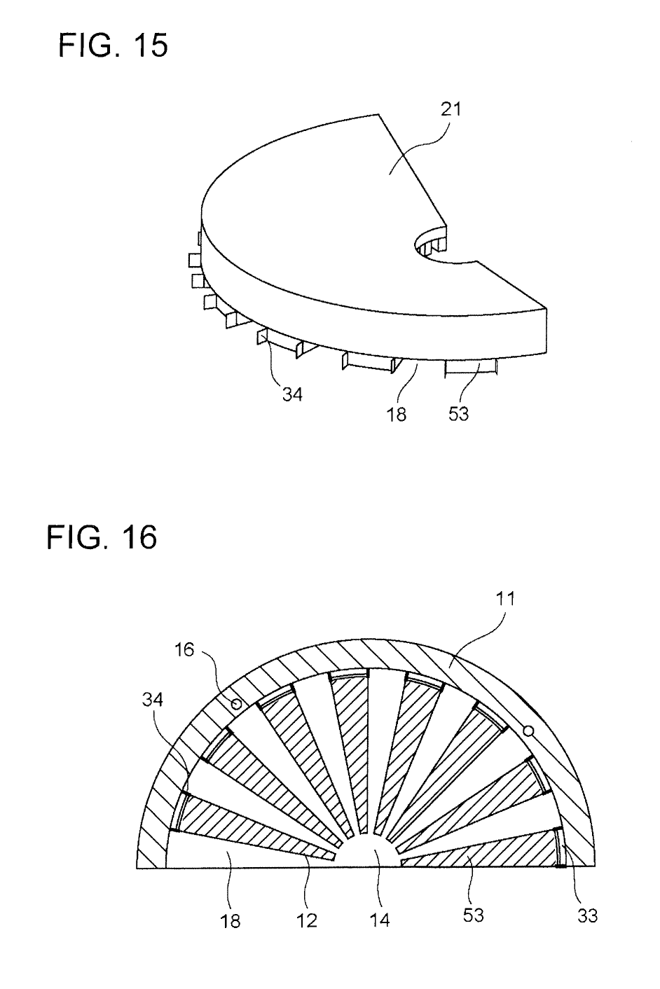

FIG. 14 is a perspective view showing a portion of a sixth embodiment of a reactor-core molten material holding device of the present invention along with a containment vessel, partly showing a cross-section view thereof. FIG. 15 is a perspective view of a portion of the reactor-core molten material holding device according to the present embodiment. FIG. 16 is a horizontal cross-sectional view showing a portion of the reactor-core molten material holding device according to the present embodiment, as well as a cross-sectional surface of a containment vessel.

The reactor-core molten material holding device 9 of the present embodiment includes block-like structures 33 that are fixed to the pedestal floor 12. The block-like structures 33 may be fixed to the pedestal side wall 11. The block-like structures 33 are provided at a plurality of locations in the circumferential direction of the pedestal side wall 11. The circumferential-direction length of the block-like structures 33 is substantially equal to the circumferential-direction length of the outer circumferential side of the legs 53 of the supporting base 21. The radial-direction width of the block-like structures 33 is substantially equal to the radial-direction width of the water supply duct vertical section 17 (See FIG. 3). The water injection pipe outlets 28, which are outlets of the water injection pipes 16, are positioned between the block-like structures 33.

At the outermost circumferential portions of the legs 53 of the supporting base 21, plate-like projecting objects 34 project from the two circumferential-direction end portions toward the pedestal side wall 11. The reactor-core molten material holding device 9 is so disposed that each of the block-like structures 33 provided on the pedestal floor 12 is sandwiched between the paired plate-like projecting objects 34 fixed to one leg 53.

According to the present embodiment, after the pedestal side wall 11 is formed, the block-like structures 33 are fixed to predetermined locations. Moreover, parts of the reactor-core molten material holding device 9 except the block-like structures 33 fixed to the pedestal side wall 11 are assembled outside the containment vessel 2 (See FIG. 2). The parts of the reactor-core molten material holding device 9 are assembled in a manufacturing facility, for example. The reactor-core molten material holding device 9 that has been assembled outside is lifted up by a crane after the pedestal floor 12 and the pedestal side wall 11 of the containment vessel 2 are formed and the block-like structures 33 are fixed to the pedestal floor 12 and the pedestal side wall 11. The reactor-core molten material holding device 9 is then installed onto the pedestal floor 12. After that, the reactor pressure vessel 1 and the like are installed.

According to the present embodiment, what is provided is a structure that interferes with and comes in contact with both the reactor-core molten material holding device 9 and the pedestal side wall 11 to suppress a change in the position. That is, the block-like structures 33 function as the position change suppression mechanism of the reactor-core molten material holding device 9. Moreover, because the block-like structures 33 fixed to the pedestal floor 12 and the pedestal side wall 11 are sandwiched between the plate-like projecting objects 34 fixed to the legs 53 of the supporting base 21, the circumferential-direction rotation of the reactor-core molten material holding device 9 is suppressed.

In this manner, according to the present embodiment, the reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

### Seventh Embodiment

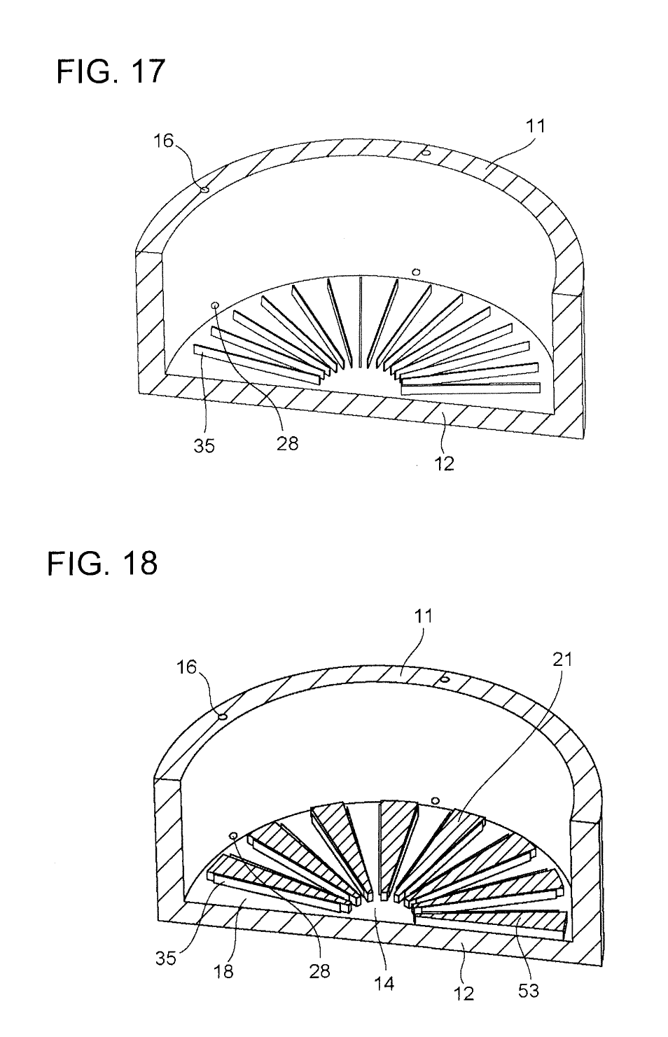

FIG. 17 is a perspective view showing a portion of a seventh embodiment of a reactor-core molten material holding device of the present invention along with a containment vessel, partly showing a cross-section view thereof. FIG. 18 is a perspective view showing a portion of the reactor-core molten material holding device according to the present embodiment along with a containment vessel.

The reactor-core molten material holding device of the present embodiment includes plate-like projecting objects 35 that are fixed to the pedestal floor 12 so as to stand vertically. The plate-like projecting objects 35 extend radially from a central portion of the pedestal floor 12. The legs 53 of the supporting base are disposed in the circumferential direction so as to appear in one in every two spaces between the plate-like projecting objects 35. The plate-like projecting objects 35 extend along both side surfaces of the legs 53 of the supporting base.

According to the present embodiment, after the pedestal floor 12 is formed, the plate-like projecting objects 35 are fixed to predetermined locations. Moreover, parts of the reactor-core molten material holding device 9 except the plate-like projecting objects 35 fixed to the pedestal floor 12 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 and the pedestal side wall 11 of the containment vessel 2 are formed and the plate-like projecting objects 35 are fixed to the pedestal floor 12. The reactor-core molten material holding device 9 is then installed onto the pedestal floor 12. After that, the reactor pressure vessel 1 and the like are installed.

According to the present embodiment, what is provided is a structure that interferes with and comes in contact with both the reactor-core molten material holding device 9 and the pedestal floor 12 to suppress a change in the position. That is, the legs 53 of the supporting base of the reactor-core molten material holding device are fitted onto the plate-like projecting objects 35 fixed to the pedestal floor 12, thereby restricting the radial- and circumferential-direction movement of the reactor-core molten material holding device. The plate-like projecting objects 35 and the legs 53 of the supporting base function as the position change suppression mechanism of the reactor-core molten material holding device.

In that manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, the horizontal cross-sectional surface of the water supply duct horizontal section 18 is in a fan shape. Alternatively, for example, the horizontal cross-sectional surface of the water supply duct horizontal section 18 may be shaped linearly. In this case, a plurality of plate-like projecting objects 35 are so disposed as to extend parallel to each other in the radial direction in accordance with the shape of the water supply duct horizontal sections 18.

According to the present embodiment, after the plate-like projecting objects 35 of the reactor-core molten material holding device 9 are fixed to the pedestal floor 12, the remaining portions are lifted down into the space surrounded by the pedestal side wall 11. Therefore, during the lifting down operation, between the parts of the reactor-core molten material holding device 9 except the plate-like projecting objects 35 fixed to the pedestal floor 12 and the pedestal side wall 11, there is a gap that is equivalent to the width of the water supply duct vertical section 17. Consequently, during the lifting down operation, the parts of the reactor-core molten material holding device 9 except the plate-like projecting objects 35 fixed to the pedestal floor 12 are less likely to interfere with the pedestal side wall 11, and it becomes easier to carry out the lifting down operation.

In that manner, the modular construction method is employed. Therefore, it is possible to shorten the construction period, and make improvements in terms of workability and construction safety, as well as in the quality of the reactor-core molten material holding device 9. Furthermore, since an existing pedestal structure is employed, there is no need to design a new pedestal structure.

### Eighth Embodiment

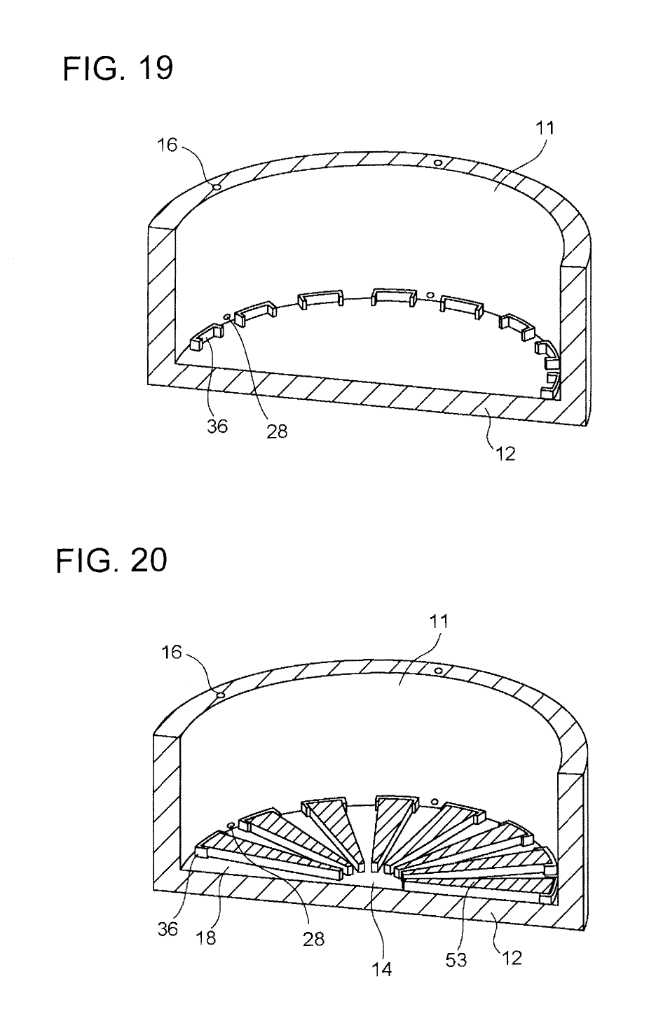

FIG. 19 is a perspective view showing a portion of an eighth embodiment of a reactor-core molten material holding device of the present invention along with a containment vessel, partly showing a cross-section view thereof. FIG. 20 is a perspective view showing a portion of the reactor-core molten material holding device according to the present embodiment along with a containment vessel.

The reactor-core molten material holding device of the present embodiment includes fitting projecting objects 36 that are fixed to the pedestal floor 12 so as to stand vertically. The fitting projecting objects 36 are disposed on the pedestal floor 12 so as to be spaced out along an inner circumferential surface of the pedestal side wall 11. Each of the fitting projecting objects 36 includes: a portion that extends along the inner circumferential surface of the pedestal side wall 11; and portions that project from the two ends of the above portion toward a radial-direction inner side. Outer circumferential end portions of the legs 53 of the supporting base are fitted into the fitting projecting objects 36. Each of the water injection pipe outlets 28 is disposed between the fitting projecting objects 36.

According to the present embodiment, after the pedestal floor 12 is formed, the fitting projecting objects 36 are fixed to predetermined locations. Parts of the reactor-core molten material holding device except the fitting projecting objects 36 fixed to the pedestal floor 12 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 and pedestal side wall 11 of the containment vessel 2 are formed and the fitting projecting objects 36 are fixed to the pedestal floor 12. The reactor-core molten material holding device 9 is then installed onto the pedestal floor 12. After that, the reactor pressure vessel 1 and the like are installed.

According to the present embodiment, what is provided is a structure that interferes with and comes in contact with both the reactor-core molten material holding device 9 and the pedestal floor 12 to suppress a change in the position. That is, the legs 53 of the supporting base of the reactor-core molten material holding device are fitted into the fitting projecting objects 36 fixed to the pedestal floor 12, thereby restricting the radial- and circumferential-direction movement of the reactor-core molten material holding device. The fitting projecting objects 36 and the legs 53 of the supporting base function as the position change suppression mechanism of the reactor-core molten material holding device.

In that manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, the outer diameter of the reactor-core molten material holding device 9 is smaller than the inner diameter of the pedestal side wall 11. The difference between the outer diameter and the inner diameter is equal to the size of the water supply duct vertical section 17. During the lifting down operation, a gap that exists between the reactor-core molten material holding device 9 and the pedestal side wall 11 is equal to the width of the water supply duct vertical section 17. As a result, during the lifting down operation, the reactor-core molten material holding device 9 is less likely to interfere with the pedestal side wall 11, and it becomes easier to carry out the lifting down operation.

The fitting projecting objects 36 of the present embodiment include the portions that project in the radial direction at both the circumferential-direction ends. However, for example, projecting objects that each includes a portion projecting in the radial direction at one circumferential-direction end may be so arranged that the left-side and right-side protruding end portions appear alternately; in this manner, the rotation of the reactor-core molten material holding device 9 is preventable.

### Ninth Embodiment

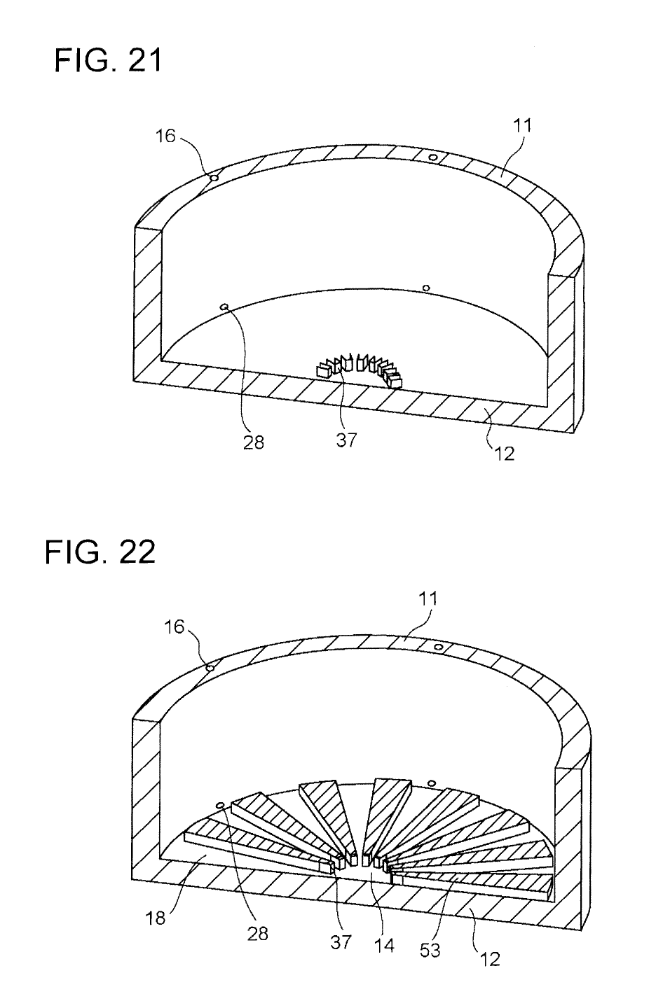

FIG. 21 is a perspective view showing a portion of a ninth embodiment of a reactor-core molten material holding device of the present invention along with a containment vessel, partly showing a cross-section view thereof. FIG. 22 is a perspective view showing a portion of the reactor-core molten material holding device according to the present embodiment along with a containment vessel.

The reactor-core molten material holding device of the present embodiment includes fitting projecting objects 36 that are fixed to the pedestal floor 12 so as to stand vertically. The fitting projecting objects 37 are disposed on the pedestal floor 12 so as to be spaced out along an outer circumference of the water supply container 14. The fitting projecting objects 37 each includes: a portion that extends along the outer circumference of the water supply container 14; and portions that project from the two ends of the above portion toward a radial-direction outer side. Inner circumferential end portions of the legs 53 of the supporting base are fitted into the fitting projecting objects 36.

According to the present embodiment, after the pedestal floor 12 is formed, the fitting projecting objects 37 are fixed to predetermined locations. Parts of the reactor-core molten material holding device except the fitting projecting objects 37 fixed to the pedestal floor 12 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 and the pedestal side wall 11 of the containment vessel 2 are formed and the fitting projecting objects 37 are fixed to the pedestal floor 12. The reactor-core molten material holding device is then installed onto the pedestal floor 12. After that, the reactor pressure vessel 1 and the like are installed.

According to the present embodiment, what is provided is a structure that interferes with and comes in contact with both the reactor-core molten material holding device 9 and the pedestal floor 12 to suppress a change in the position. That is, the legs 53 of the supporting base of the reactor-core molten material holding device are fitted into the fitting projecting objects 37 fixed to the pedestal floor 12, thereby restricting the radial- and circumferential-direction movement of the reactor-core molten material holding device. The fitting projecting objects 37 and the legs 53 of the supporting base function as the position change suppression mechanism of the reactor-core molten material holding device.

In that manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, the outer diameter of the reactor-core molten material holding device 9 is smaller than the inner diameter of the pedestal side wall 11. The difference between the outer diameter and the inner diameter is equal to the size of the water supply duct vertical section 17. During the lifting down operation, a gap that exists between the reactor-core molten material holding device 9 and the pedestal side wall 11 is equal to the width of the water supply duct vertical section 17. As a result, during the lifting down operation, the reactor-core molten material holding device 9 is less likely to interfere with the pedestal side wall 11, and it becomes easier to carry out the lifting down operation.

The fitting projecting objects 36 of the present embodiment include the portions that project in the radial direction at both the circumferential-direction ends. However, for example, projecting objects that each includes a portion projecting in the radial direction at one circumferential-direction end may be so arranged that the left-side and right-side protruding end portions appear alternately. In this manner, the rotation of the reactor-core molten material holding device 9 may be preventable.

### Tenth Embodiment

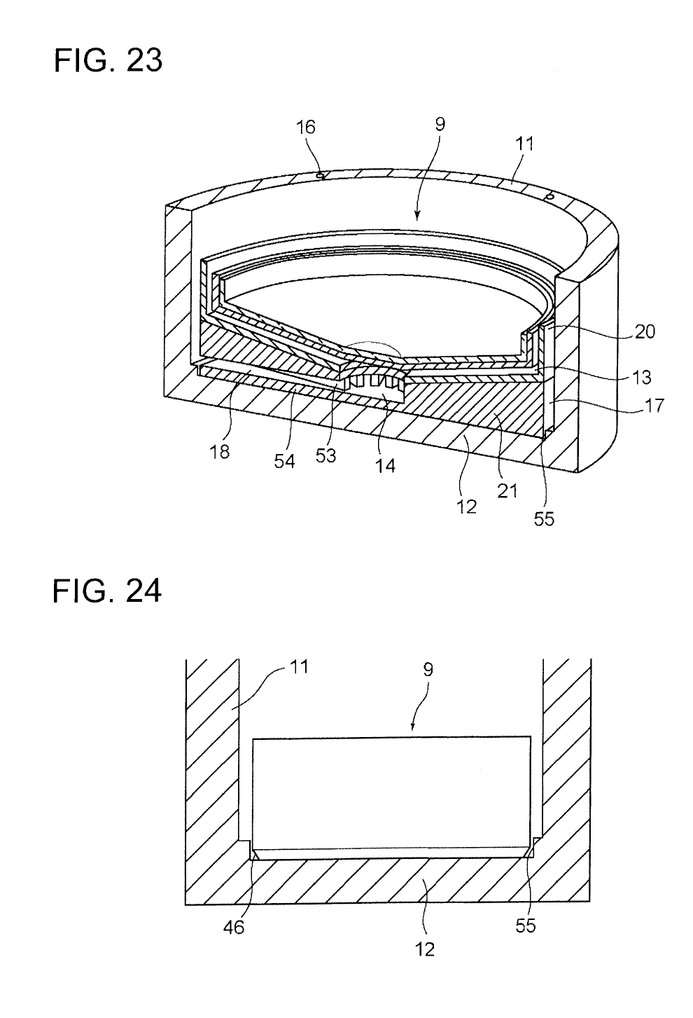

FIG. 23 is a perspective view showing a tenth embodiment of a reactor-core molten material holding device of the present invention along with a containment vessel, partly showing a cross-section view thereof.

The reactor-core molten material holding device 9 of the present embodiment includes a bottom plate 54 at a lower end of the supporting base 21. On a top surface of the bottom plate 54, the legs 53 are so provided as to extend radially and horizontally from the center. Between the adjacent legs 53, the cooling water ducts 13 are so formed as to extend along the top surface of the bottom plate 54.

On the pedestal floor 12, a dent 55 is so formed that the inner diameter of the dent 55 is substantially equal to the outer diameter of the bottom plate 54. The depth of the dent 55 is substantially equal to the thickness of the bottom plate 54.

According to the present embodiment, after the pedestal floor 12 is formed, the fitting projecting portions 37 are fixed to predetermined locations.

Parts of the reactor-core molten material holding device are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 having a predetermined dent 55 and the pedestal side wall 11 are formed. The reactor-core molten material holding device is then installed onto the pedestal floor 12 in such a way that the bottom plate 54 of the supporting base 21 is fitted into the dent 55 of the pedestal floor 12. After that, the reactor pressure vessel 1 and the like are installed.

According to the present embodiment, what is provided is a structure that interferes with and comes in contact with both the reactor-core molten material holding device 9 and the pedestal floor 12 to suppress a change in the position. That is, the bottom plate 54 fixed to the supporting base 21 is fitted into the dent 55 formed in the pedestal floor 12, thereby restricting the radial-direction movement of the reactor-core molten material holding device. The dent 55 and the bottom plate 54 of the supporting base 21 function as the position change suppression mechanism of the reactor-core molten material holding device 9.

FIG. 24 is a vertical cross-sectional view of a nearby area of a reactor-core molten material holding device according to a modified example of the present embodiment.

In the modified example, on an outer circumferential portion of the bottom plate 54 fixed to the lower end of the supporting base 21, a tapered portion 46 is formed. That is, in a portion where the fixed and movable sides of the position change suppression mechanism, which are the dent 55 and the bottom plate 54 respectively, come in contact with each other, the tapered portion 46 is formed in a portion that is the first to pass through a nearby area of the fixed-side mechanism during a lifting down operation.

The narrowest portion that is the first to pass through a fixed portion in the position change suppression mechanism as the reactor-core molten material holding device 9 is lifted down is formed into a tapered structure. Therefore, the insertion performance of the contact portion is improved at a time when the reactor-core molten material holding device 9 is lifted down. Because the insertion performance of the contact portion at a time when the reactor-core molten material holding device 9 is lifted down is improved, it is possible to easily install the reactor-core molten material holding device 9 and make improvements in terms of workability.

In this manner, according to the present embodiment, the reactor-core molten material holding device 9 is equipped with the position change suppression mechanism. Therefore, without the need to fix the reactor-core molten material holding device 9 to the pedestal floor 12 and the like with anchor bolts or the like, an installation central axis of the reactor-core molten material holding device 9 does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, after the bottom plate 54 of the supporting base 21 is fitted into the dent 55 of the pedestal floor 12, the water injection pipe outlets 28 (See FIG. 6), which are outlets of the water injection pipes 16, are not blocked by the legs 53 of the supporting base 21 and the bottom plate 54. Therefore, a rotational-direction change in the position of the reactor-core molten material holding device 9 has almost no effects on the retention/cooling performance for reactor-core molten materials; and it is easy to carry out the installation operation.

According to the present embodiment, the outer diameter of the reactor-core molten material holding device 9 is smaller than the inner diameter of the pedestal side wall 11. The difference between the outer diameter and the inner diameter is equal to the size of the water supply duct vertical section 17. During the lifting down operation, a gap that exists between the reactor-core molten material holding device 9 and the pedestal side wall 11 is equal to the width of the water supply duct vertical section 17. As a result, during the lifting down operation, the reactor-core molten material holding device 9 is less likely to interfere with the pedestal side wall 11, and it becomes easier to carry out the lifting down operation.

### Eleventh Embodiment

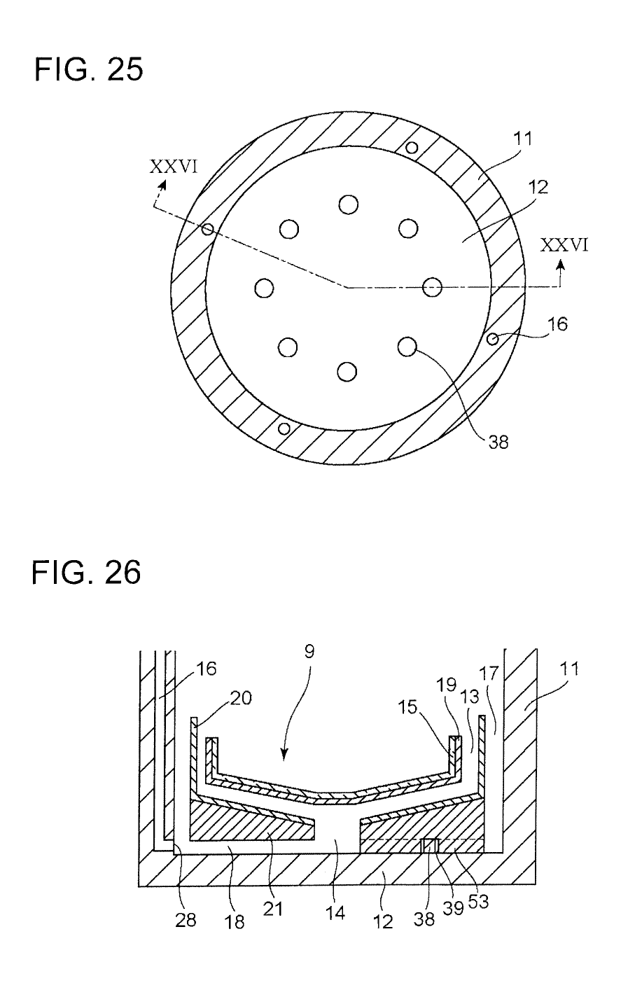

FIG. 25 is a horizontal cross-sectional view of a nearby area of a pedestal floor according to an eleventh embodiment of a reactor-core molten material holding device of the present invention. FIG. 26 is a vertical cross-sectional view taken along arrows XXVI-XXVI of FIG. 25, as well as a vertical cross-sectional view showing a nearby area of the reactor-core molten material holding device of the present embodiment.

According to the present embodiment, on the pedestal floor 12, supporting posts 38 are so provided as to extend vertically upward. The supporting posts 38 are fixed to the pedestal floor 12. There are a plurality of supporting posts 38. For example, eight supporting posts 38 are provided in a space between the water supply container 14 and the pedestal side wall 11 so as to be spaced out in the circumferential direction. At a lower end of the supporting base 21, dents 39 are formed, and the supporting posts 38 are fitted into the dents 39.

Parts of the reactor-core molten material holding device 9 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12, the supporting posts 38, which are placed on the pedestal floor 12, and the pedestal side wall 11 are formed. The reactor-core molten material holding device is then installed onto the pedestal floor 12 in such a way that the supporting posts 38 are fitted into the dents 39 of the supporting base 21. After that, the reactor pressure vessel 1 and the like are installed.

According to the present embodiment, what is formed is a structure that interferes with and comes in contact with both the reactor-core molten material holding device 9 and the pedestal floor 12 to suppress a change in the position. That is, the supporting posts 38 placed on the pedestal floor 12 are fitted into the dents 39 formed on the lower end of the supporting base 21, thereby restricting the radial- and circumferential-direction movement of the reactor-core molten material holding device. The supporting posts 38 and the dents 39 of the supporting base 21 function as the position change suppression mechanism of the reactor-core molten material holding device 9.

In this manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, the outer diameter of the reactor-core molten material holding device 9 is smaller than the inner diameter of the pedestal side wall 11. The difference between the outer diameter and the inner diameter is equal to the size of the water supply duct vertical section 17. During the lifting down operation, a gap that exists between the reactor-core molten material holding device 9 and the pedestal side wall 11 is equal to the width of the water supply duct vertical section 17. As a result, during the lifting down operation, the reactor-core molten material holding device 9 is less likely to interfere with the pedestal side wall 11, and it becomes easier to carry out the lifting down operation.

### Twelfth Embodiment

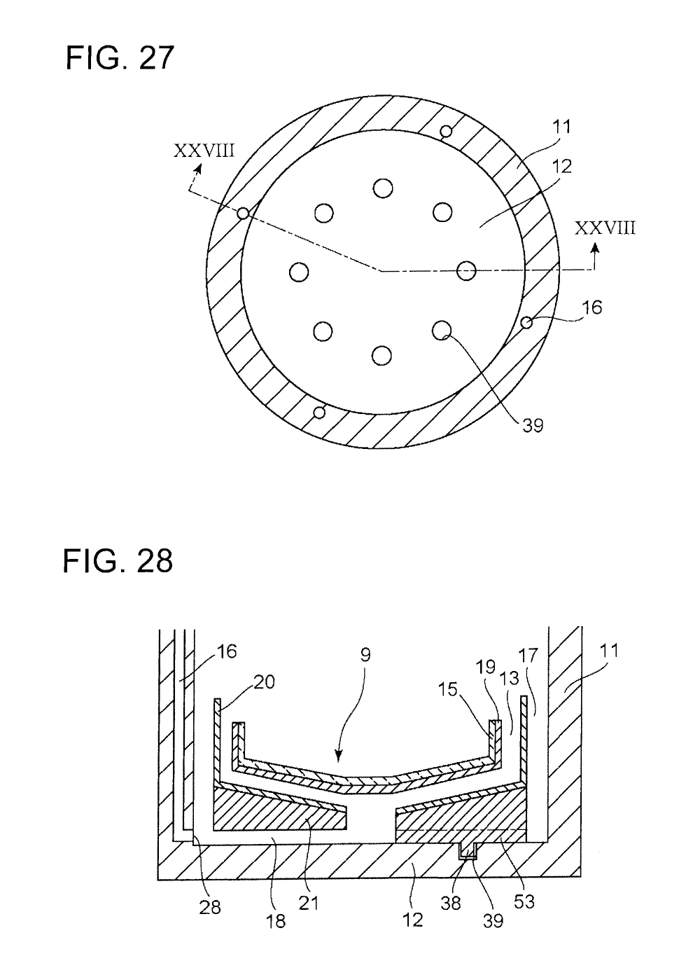

FIG. 27 is a horizontal cross-sectional view of a nearby area of a pedestal floor according to a twelfth embodiment of a reactor-core molten material holding device of the present invention. FIG. 28 is a vertical cross-sectional view taken along arrows XXVIII-XXVIII of FIG. 27, as well as a vertical cross-sectional view showing a nearby area of the reactor-core molten material holding device of the present embodiment.

According to the present embodiment, on the pedestal floor 12, dents 39 are so formed as to extend vertically downward. For example, eight dents 39 are formed in a space between the water supply container 14 and the pedestal side wall 11 so as to be spaced out in the circumferential direction. On a lower end of the supporting base 21, supporting posts 38 are fixed, and the supporting posts 38 are fitted into the dents 39.

Parts of the reactor-core molten material holding device 9 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 having the dents 39, and the pedestal side wall 11 are formed. The reactor-core molten material holding device is then installed onto the pedestal floor 12 in such a way that the supporting posts 38 are fitted into the dents 39 formed in the pedestal floor 12. After that, the reactor pressure vessel 1 and the like are installed.

According to the present embodiment, what is formed is a structure that interferes with and comes in contact with both the reactor-core molten material holding device 9 and the pedestal floor 12 to suppress a change in the position. That is, the supporting posts 38 provided on the lower end of the supporting base 21 are fitted into the dents 39 formed in the pedestal floor 12, thereby restricting the radial- and circumferential-direction movement of the reactor core molten material holding device. The supporting posts 38 and the dents 39 function as the position change suppression mechanism of the reactor-core molten material holding device 9.

In this manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, the outer diameter of the reactor-core molten material holding device 9 is smaller than the inner diameter of the pedestal side wall 11. The difference between the outer diameter and the inner diameter is equal to the size of the water supply duct vertical section 17. During the lifting down operation, a gap that exists between the reactor-core molten material holding device 9 and the pedestal side wall 11 is equal to the width of the water supply duct vertical section 17. As a result, during the lifting down operation, the reactor-core molten material holding device 9 is less likely to interfere with the pedestal side wall 11, and it becomes easier to carry out the lifting down operation.

### Thirteenth Embodiment

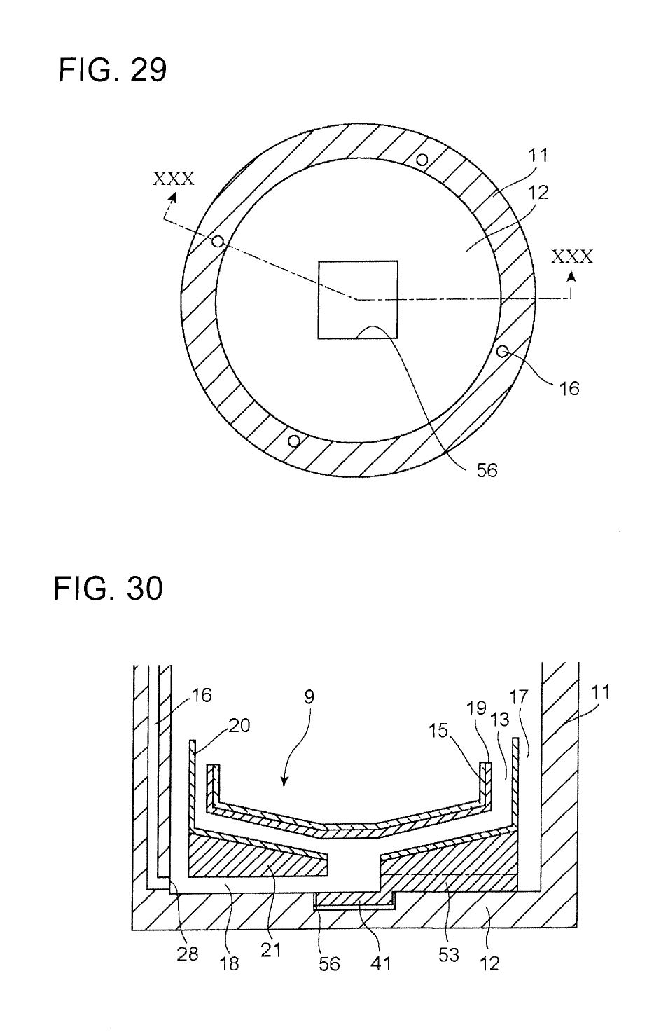

FIG. 29 is a horizontal cross-sectional view of a nearby area of a pedestal floor according to a thirteenth embodiment of a reactor-core molten material holding device of the present invention. FIG. 30 is a vertical cross-sectional view taken along arrows XXX-XXX of FIG. 29, as well as a vertical cross-sectional view showing a nearby area of the reactor-core molten material holding device of the present embodiment.

According to the present embodiment, on the pedestal floor 12, a dent 39 is so formed as to extend vertically downward. The dent 56 is so formed that the horizontal cross-sectional surface of the dent 56 is in a polygonal shape. For example, the dent 56 is formed in a central portion of the pedestal floor 12, and is a non-penetrating hole whose horizontal cross-sectional surface is in a square shape. The dent 56 may be formed into any shape other than square as long as the shape is polygonal. On a lower end of the supporting base 21, a supporting post 41 is formed, and the supporting post 41 is fitted into the dent 56.

Parts of the reactor-core molten material holding device 9 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 having the dent 56, and the pedestal side wall 11 are formed. The reactor-core molten material holding device is then installed onto the pedestal floor 12 in such a way that the supporting post 41 is fitted into the dent 56 formed in the pedestal floor 12. After that, the reactor pressure vessel 1 and the like are installed.

According to the present embodiment, what is formed is a structure that interferes with and comes in contact with both the reactor-core molten material holding device 9 and the pedestal floor 12 to suppress a change in the position. That is, the supporting post 41 provided on the lower end of the supporting base 21 is fitted into the dent 56 formed in the pedestal floor 12, thereby restricting the radial- and circumferential-direction movement of the reactor-core molten material holding device. The supporting post 41 and the dent 56 function as the position change suppression mechanism of the reactor-core molten material holding device 9.

In this manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

According to the present embodiment, the outer diameter of the reactor-core molten material holding device 9 is smaller than the inner diameter of the pedestal side wall 11. The difference between the outer diameter and the inner diameter is equal to the size of the water supply duct vertical section 17. During the lifting down operation, a gap that exists between the reactor-core molten material holding device 9 and the pedestal side wall 11 is equal to the width of the water supply duct vertical section 17. As a result, during the lifting down operation, the reactor-core molten material holding device 9 is less likely to interfere with the pedestal side wall 11, and it becomes easier to carry out the lifting down operation.

Furthermore, the supporting post 41 and the dent 56 are formed in a polygonal shape. Therefore, one supporting post 41 and one dent 56 are enough to restrict the rotation of the reactor-core molten material holding device 9.

### Fourteenth Embodiment

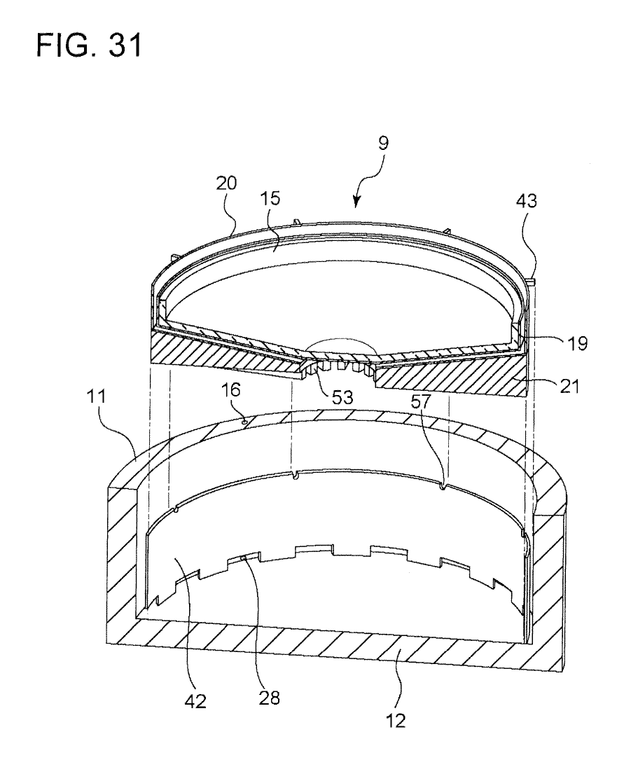

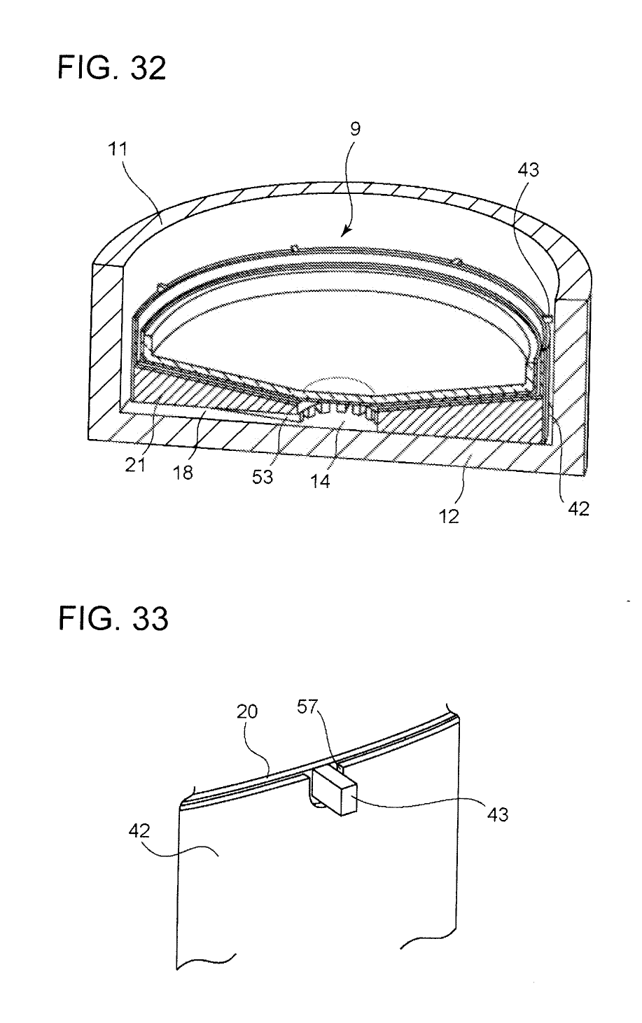

FIG. 31 is a perspective view showing a cross-sectional plane of a portion of a nearby area of a pedestal floor during a lifting down operation according to a fourteenth embodiment of a reactor-core molten material holding device of the present invention. FIG. 32 is a perspective view showing a cross-sectional plane of a portion of a nearby area of the reactor-core molten material holding device according to the present embodiment. FIG. 33 is a perspective view of a nearby area of a supporting plate according to the present embodiment.

According to the present embodiment, on the pedestal floor 12, a circular tube supporting structure 42 is fixed. The circular tube supporting structure 42 is a circular tube that is smaller in diameter than the inner diameter of the pedestal side wall 11. At a lower end of the circular tube supporting structure 42, a gap is formed so as to allow cooling water to flow from the outer side of the circular tube supporting structure 42 to the inner side. At the upper end of the circular tube supporting structure 42, notches 57 are formed. The notches 57 are formed at a plurality of locations in the circumferential direction of the circular tube supporting structure 42.

On the outer riser 20 of the reactor-core molten material holding device 9, supporting plates 43 are so fixed as to project toward the pedestal side wall 11. The supporting plates 43 fixed to the outer riser 20 engage with the notches 57 of the circular tube supporting structure 42.

Parts of the reactor-core molten material holding device 9 are assembled outside the containment vessel 2 (See FIG. 2). The parts of the reactor-core molten material holding device 9 are assembled in a manufacturing facility, for example. The reactor-core molten material holding device that has been assembled outside is lifted up by a crane after the pedestal floor 12 and the pedestal side wall 11 are formed and the circular tube supporting structure 42 is fixed to the pedestal floor 12. The reactor-core molten material holding device 9 lifted by the crane is then installed onto the pedestal floor 12 in such a way that the supporting plates 43 fixed to the outer riser 20 engage with the notches 57 formed on the circular tube supporting structure 42. After that, the reactor pressure vessel 1 and the like are installed.

According to the present embodiment, the supporting plates 43 fixed to the outer riser 20 engage with the notches 57 of the circular tube supporting structure 42 fixed to the pedestal floor 12, thereby restricting the radial- and circumferential-direction movement of the reactor-core molten material holding device 9. That is, the supporting plates 43 and the notches 57 of the circular tube supporting structure 42 function as the position change suppression mechanism of the reactor-core molten material holding device 9.

Instead of an unbroken structure that extends in the circumferential direction such as the circular tube supporting structure 42, the following structures may be alternatively applicable as long as the structures have notches with which the supporting plates 43 engage, and are strong enough to resist earthquakes and the like: a collection of structures divided in the circumferential direction, and a collection of columnar structures.

In this manner, according to the present embodiment, the reactor-core molten material holding device is equipped with the position change suppression mechanism. Therefore, without the need to fix the reactor-core molten material holding device 9 to the pedestal floor 12 and the like with anchor bolts or the like, an installation central axis of the reactor-core molten material holding device does not move significantly even when airplane crash accidents or vibration caused by earthquake and so on take place. That is, after the reactor-core molten material holding device 9 is installed, a change in the position of the reactor-core molten material holding device 9 is suppressed. As a result, it is possible to suppress the amounts of flowing cooling water distributed into a plurality of cooling water ducts 13 from changing wildly.

The supporting plates 43 fixed to the outer riser 20 function as the position change suppression mechanism only when the supporting plates 43 engage with the notches 57 of the circular tube supporting structure 42. Therefore, there is no need to bring the end portions of the supporting plates 43 so much closer to the pedestal side wall 11. Accordingly, during the operation of lifting the reactor-core molten material holding device 9, a gap of a certain size can be provided between the pedestal side wall 11 and the reactor-core molten material holding device 9. Therefore, it is easy to carry out the lifting down operation.

### Other Embodiments

The above-described embodiments are given for illustrative purposes only. The present invention is not limited to the embodiments described above. The present invention may be embodied by combining the features of the embodiments.

What is claimed is:

1. A nuclear reactor containment vessel that stores a reactor vessel in which a reactor core is stored, the vessel comprising:
a pedestal floor which is provided below the reactor vessel;
a pedestal side wall which rises vertically from the pedestal floor and in which a water injection outlet from which cooling water is released is formed;
a reactor-core molten material holding device which includes:
a holding container that is placed on the pedestal floor and has an outer circumferential surface that faces an inner surface of the pedestal side wall across a gap and is opened upward at an inner side of the outer circumferential surface, and
a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed; and
decentering prevention bodies which are disposed at least at three locations that are different in terms of circumferential-direction position of the outer circumferential surface and between the outer circumferential surface and the inner surface of the pedestal side wall.

2. The nuclear reactor containment vessel according to claim 1, wherein
the decentering prevention bodies include spacers that hang on an upper end of the outer circumferential surface and extend between the outer circumferential surface and the pedestal side wall.

3. The nuclear reactor containment vessel according to claim 2, further comprising
buffers which are provided in portions where the spacers and the pedestal side wall face each other.

4. The nuclear reactor containment vessel according to claim 1, wherein
the decentering prevention bodies include projecting portions which are fixed to the reactor-core molten material holding device and project from the outer circumferential surface toward the pedestal side wall.

5. The nuclear reactor containment vessel according to claim 4, wherein
the reactor-core molten material holding device includes legs, which extend from the water supply container toward the outer circumferential surface, at a lower end thereof, and
the projecting portions are fixed to end portions of the legs that face the pedestal side wall.

6. The nuclear reactor containment vessel according to claim 5, wherein
the water injection outlet is formed at a higher position than an upper ends of the projecting portions.

7. The nuclear reactor containment vessel according to claim 4, wherein
the reactor-core molten material holding device includes: a supporting base which is placed on the pedestal floor, and a tubular outer riser which extends upward from an upper end of the supporting base; and
the projecting portions are fixed to an outer surface of the outer riser.

8. The nuclear reactor containment vessel according to claim 7, wherein
on the projecting portions, a lift jig hole is so formed as to pass therethrough in a horizontal direction.

9. The nuclear reactor containment vessel according to claim 4, further comprising
rotation prevention bodies which are fixed to the pedestal side wall and face to the projecting portion in two different directions each, along the outer circumferential surface.

10. The nuclear reactor containment vessel according to claim 9, wherein
at a lower end outer side of each of the projecting portions, a tapered portion is so formed that a distance from the pedestal side wall becomes gradually smaller toward an upper area from a lower area.

11. The nuclear reactor containment vessel according to claim 9, further comprising
buffers which are provided in portions where the rotation prevention bodies and the projecting portions face each other.

12. A nuclear reactor containment vessel that stores a reactor vessel in which a reactor core is stored, the vessel comprising:
a pedestal floor which is provided below the reactor vessel;
a pedestal side wall which rises vertically from the pedestal floor and in which a water injection outlet from which cooling water is released is formed;
a reactor-core molten material holding device which includes:
a holding container that is placed on the pedestal floor and has an outer circumferential surface that faces an inner surface of the pedestal side wall across a gap and is opened upward at an inner side of the outer circumferential surface, and
a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed; and
a flange which is fixed to a lower end of the reactor-core molten material holding device and whose vertical-direction projected area is larger than the outer circumferential surface.

13. The nuclear reactor containment vessel according to claim 12, wherein
the water injection outlet is formed at a higher position than an upper surface of the flange.

14. The nuclear reactor containment vessel according to claim 12, further comprising
a buffer which is provided in a portion where a side face of the flange and an inner surface of the pedestal side wall face each other.

15. A nuclear reactor containment vessel that stores a reactor vessel in which a reactor core is stored, the vessel comprising:
a pedestal floor which is provided below the reactor vessel;
a pedestal side wall which rises vertically from the pedestal floor and in which a water injection outlet from which cooling water is released is formed; and
a reactor-core molten material holding device which includes:
a holding container that is placed on the pedestal floor and has an outer circumferential surface that faces an inner surface of the pedestal side wall across a gap and is opened upward at an inner side of the outer circumferential surface, and
a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed, wherein
a dent is formed either on the pedestal floor or a lower surface of the reactor-core molten material holding device, and a projection, which is fitted into the dent, is formed either on a lower surface of the reactor-core molten material holding device or on the pedestal floor.

16. The nuclear reactor containment vessel according to claim 15, wherein
there are a plurality of the dents and a plurality of the projections.

17. The nuclear reactor containment vessel according to claim 15, wherein
the dents and the projections are formed in a polygonal shape.

18. The nuclear reactor containment vessel according to claim 15, wherein
at a tip outer side of the projection, a tapered portion is so formed that a distance from the dent becomes gradually smaller toward further end of the projection from the tip.

19. The nuclear reactor containment vessel according to claim 15, further comprising
a buffer which is provided between portions where an inner surface of the dent and an outer surface of the projection face each other.

20. A nuclear reactor containment vessel that stores a reactor vessel in which a reactor core is stored, the vessel comprising:
a pedestal floor which is provided below the reactor vessel;
a pedestal side wall which rises vertically from the pedestal floor and in which a water injection outlet from which cooling water is released is formed;
a reactor-core molten material holding device which includes:
a holding container that is placed on the pedestal floor and has an outer circumferential surface that faces an inner surface of the pedestal side wall across a gap and is opened upward at an inner side of the outer circumferential surface, and
a water supply container that is provided below the holding container, wherein a water supply duct that extends from a gap between the outer circumferential surface and the inner surface of the pedestal side wall to the water supply container, and a cooling duct that extends from the water supply container along a lower surface of the holding container are formed; and
a tubular supporting structure which rises from the pedestal floor along the outer circumferential surface and on which a notch is formed on an upper end thereof; and
a rotation prevention projecting portion which is fixed to the reactor-core molten material holding device, and which projects from the outer circumferential surface toward the pedestal side wall to engage with the notch.

21. The nuclear reactor containment vessel according to claim 20, wherein
at an outer circumferential portion of a lower end of the reactor-core molten material holding device, a tapered portion is so formed that a distance from the tubular supporting structure becomes gradually smaller toward further end of the reactor-core molten material holding device from the lower end.
